(19) United States
(12) Patent Application Publication
(10) Pub. No.: US 2025/0031218 A1
(43) Pub. Date: Jan. 23, 2025

(54) METHOD AND DEVICE IN NODES USED FOR WIRELESS COMMUNICATION

(71) Applicants: Qi JIANG, Shanghai (CN); Ping WANG, Shanghai (CN); Xiaobo ZHANG, Shanghai (CN)

(72) Inventors: Qi JIANG, Shanghai (CN); Ping WANG, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/772,283

(22) Filed: Jul. 15, 2024

(30) Foreign Application Priority Data
Jul. 21, 2023 (CN) 202310905276.3

(51) Int. Cl. H04W 72/231; H04B 7/06; H04W 72/0446; H04W 72/12

(52) U.S. Cl. CPC H04W 72/231; H04B 7/06968; H04W 72/0446; H04W 72/12

(57) ABSTRACT

A first node receives a first DCI, the first DCI comprising a first field, the first field indicating a minimum applicable scheduling offset; a minimum scheduling offset value set includes K1 candidate minimum scheduling offset values, the minimum applicable scheduling offset being one of the K1 candidate minimum scheduling offset values; the minimum scheduling offset value set is one of multiple candidate minimum scheduling offset value sets; determining the minimum scheduling offset value set from the multiple candidate minimum scheduling offset value sets depends on one of: a resource occupied by the first DCI; or a time-domain resource occupied by a channel or signal scheduled by the first DCI; or a reference signal resource QCL with a physical layer channel scheduled by the first DCI. This application improves the scheme for determining the minimum applicable scheduling offset to support cross-slot scheduling for various scenarios, including full-duplex scenarios.

### CROSS REFERENCE TO RELATED APPLICATIONS

This application claims the priority benefit of Chinese Patent Application No.202310905276.3, filed on Jul. 21, 2023, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 session to standardize the NR.

In existing NR systems, spectrum resources are statically divided into Frequency Division Duplexing (FDD) spectrum and Time Division Duplexing (TDD) spectrum. For TDD spectrum, both the base station and UE (i.e., User Equipment) operate in half-duplex mode. This half-duplex mode avoids self-interference and mitigates the effects of Cross Link Interference (CLI), but it also brings problems such as reduced resource utilization and increased latency. In view of these problems, to support flexible duplex mode or variable link directions (Uplink, or Downlink, or Flexible ones) on the TDD spectrum or the FDD spectrum becomes a potential solution. In the 3GPP RAN #88e meeting and the 3GPP Rel-18 (also referred to as Release-18 or version 18) workshop, the support of more flexible duplex mode or full duplex mode in NR Rel-18 has been widely noticed and discussed, especially the Subband non-overlapping Full Duplex (SBFD) mode at the gNB (NR node B) end. Communication in this mode is subject to severe interference, including self-interference and CLI. To solve the interference problem, advanced interference cancellation techniques are required, including antenna isolation, beamforming, Radio Frequency (RF)-level interference cancellation and digital interference cancellation.

### SUMMARY

In order to reduce unnecessary buffering and processing of the data channel by the terminal before decoding out Downlink Control Information (DCI), according to existing standard the base station is able to configure up to two minimum applicable scheduling offsets, i.e., K₀ₘᵢₙ, for downlink cross-slot scheduling per DownLink BandWidth Part (per DL BWP) and up to two minimum applicable scheduling offsets, i.e., K₂ₘᵢₙ, for uplink cross-slot scheduling per UpLink (UL) BWP; the terminal dynamically adjusts K₀ₘᵢₙ and K₂ₘᵢₙ according to the indications in the scheduling DCI to achieve the effect of lowering the power consumption of the terminal.

However, in the SBFD scenario, the base station may use different panels/antennas for SBFD and non-SBFD symbols, and the terminal needs to re-tune the filter and adjust the sampling rate when switching between SBFD and non-SBFD symbols, so the switching between SBFD symbols and non-SBFD symbols may require a guard period to switch panels, tune the sampling rate, and adjust the sampling rate. guard period) to switch panels, tune filters, and adjust timing; if the base station configures a small K₀ₘᵢₙ and K₂ₘᵢₙ for the UE, it may lead to transmission failures due to untimely buffering of the data channel, whereas an overly large K₀ₘᵢₙ and K₂ₘᵢₙ will introduce unnecessary transmission delays, therefore, the minimum applicable scheduling offsets shall be enhanced in terms of cross-slot scheduling in SBFD scenarios.

To address the above problem, the present application provides a solution. It should be noted that although the original intent of this application is for SBFD scenarios, this application can also be applied to other non-SBFD scenarios; further, the adoption of a unified design scheme for different scenarios (e.g., other non-SBFD scenarios including, but not limited to, capacity augmentation systems, systems for near field communications, unlicensed spectrum communications, Internet of Things (IoT), Ultra Reliable Low Latency Communication (URLLC) networks, Vehicle-to-everything (V2X), etc.) also helps to reduce hardware complexity and cost. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

Particularly, for interpretations of the terminology, nouns, functions and variables (unless otherwise specified) in the present application, refer to definitions given in TS38 series and TS37 series of 3GPP specifications. Refer to 3GPP TS38.211, TS38.212, TS38.213, TS38.214, TS38.215, TS38.300, TS38.304, TS38.305, TS38.321, TS38.331, TS37.355, and TS38.423, if necessary, for a better understanding of the present application.

In one embodiment, interpretations of the terminology in the present application refer to definitions given in the 3GPP TS38 series.

In one embodiment, interpretations of the terminology in the present application refer to definitions given in the 3GPP TS37 series.

The present application provides a method in a first node for wireless communications, comprising:
receiving a first DCI, the first DCI comprising a first field, the first field in the first DCI being used to indicate a minimum applicable scheduling offset;
herein, the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
   a resource occupied by the first DCI; or
   a time-domain resource occupied by a channel or signal scheduled by the first DCI; or
   a reference signal resource that is QCL with a physical layer channel scheduled by the first DCI.

In one embodiment, a problem to be solved in the present application includes: how to determine the minimum applicable scheduling offset indicated by the DCI.

In one embodiment, a problem to be solved in the present application includes: how to determine the minimum scheduling offset value set to which the minimum applicable scheduling offset indicated by the DCI belongs when the first node is configured with a plurality of candidate minimum scheduling offset value sets.

In one embodiment, characteristics of the above method include that the present application solves the above problem by indicating a minimum scheduling offset from the minimum scheduling offset value set by means of the first field of the first DCI.

In one embodiment, characteristics of the above method include that the first node in the present application is configured with a plurality of candidate minimum scheduling offset value sets, and the DCI indicating the minimum scheduling offset value implicitly indicates the minimum scheduling offset value set from the plurality of candidate minimum scheduling offset value sets, thereby solving the above problem.

In one embodiment, characteristics of the above method include that the present application determines a minimum scheduling offset value set from among the plurality of candidate minimum scheduling offset value sets based on one of three things: a resource occupied by a DCI indicating a minimum scheduling offset value, a time-domain resource occupied by a channel or signal scheduled by the DCI indicating the minimum scheduling offset value, and a reference signal resource that is QCL with the physical layer channel scheduled by the DCI indicating the minimum scheduling offset value, thus solving the above problem.

In one embodiment, characteristics of the above method include that the minimum applicable scheduling offset is K₀ₘᵢₙ and/or K₂ₘᵢₙ, and the first minimum applicable scheduling offset is applicable to dynamic downlink scheduling and/or dynamic uplink scheduling.

In one embodiment, an advantage of the above method includes: supporting cross-slot scheduling, reducing unnecessary data channel buffering, reducing the activation duration of RF circuits in the time domain, thus contributing to the reduction of terminal power consumption.

In one embodiment, an advantage of the above method includes: saving signaling overhead by eliminating the need to explicitly indicate the minimum scheduling offset value set.

In one embodiment, an advantage of the above method includes: configuring a plurality of minimum scheduling offset value sets, thus better adapting to cross-slot scheduling in different scenarios.

According to one aspect of the present application, the above method is characterized in that the resource occupied by the first DCI includes a CORESET pool; the CORESET pool occupied by the first DCI is used to determine the minimum scheduling offset value set from the multiple candidate minimum scheduling offset value sets.

In one embodiment, characteristics of the above method include that the first DCI implicitly indicates a minimum scheduling offset value set, where the implicit indication includes indicating the minimum scheduling offset value set from the plurality of candidate minimum scheduling offset value sets based on a CORESET pool occupied by the first DCI.

In one embodiment, characteristics of the above method include that the physical layer channel occupied by the first DCI includes a PDCCH, a CORESET to which the PDCCH belongs being configured with a parameter coresetPoolIndex.

In one embodiment, characteristics of the above method include that the present application supports scenarios of non-coherent joint transmission.

In one embodiment, characteristics of the above method include that the first node may determine a TRP, a default QCL reference and a resource type for a downlink channel transmission scheduled by the first DCI for transmission based on the CORESET pool occupied by the first DCI.

In one embodiment, an advantage of the above method includes: minimizing the transmission interference with different CORESET pools scheduling and improving transmission reliability.

In one embodiment, an advantage of the above method includes: configuring different candidate minimum scheduling offset value sets for DCI scheduling for different CORESET pools respectively, or associating the candidate minimum scheduling offset value sets with CORESET pools, and adopting different minimum applicable scheduling offsets for different resources, so as to provide better scheduling flexibility and resource allocation flexibility.

In one embodiment, an advantage of the above method includes: avoiding the use of additional signaling to indicate the minimum scheduling offset value set to improve spectral efficiency and save signaling overhead.

According to one aspect of the present application, the above method is characterized in that the multiple candidate minimum scheduling offset value sets are a first candidate minimum scheduling offset value set and a second candidate minimum scheduling offset value set, respectively; the time-domain resource occupied by the channel or the signal scheduled by the first DCI overlaps with a first-type symbol set, and the minimum scheduling offset value set is the first candidate minimum scheduling offset value set; the time-domain resource occupied by the channel or the signal scheduled by the first DCI is orthogonal to the first-type symbol set, and the minimum scheduling offset value set is the second candidate minimum scheduling offset value set.

In one embodiment, characteristics of the above method include that the first DCI implicitly indicates a minimum scheduling offset value set, where the implicit indication includes indicating the minimum scheduling offset value set from the plurality of candidate minimum scheduling offset value sets based on a time-domain resource occupied by the channel or the signal scheduled by the first DCI.

In one embodiment, characteristics of the above method include that the first DCI implicitly indicates a minimum scheduling offset value set, where the implicit indication includes indicating the minimum scheduling offset value set from the plurality of candidate minimum scheduling offset value sets based on whether a time-domain resource occupied by the channel or the signal scheduled by the first DCI overlaps with the first-type symbol set.

In one embodiment, characteristics of the above method include that the first-type symbol set includes full duplex symbols.

In one embodiment, characteristics of the above method include that the present application is applicable to full-duplex scenarios, the full-duplex scenarios including SBFD scenarios.

In one embodiment, an advantage of the above method includes: supporting full duplex scenarios, which facilitates increasing uplink coverage.

In one embodiment, an advantage of the above method includes that a first candidate minimum scheduling offset value set and a second candidate minimum scheduling offset value set are respectively for scenarios in which a channel or signal scheduled by the first DCI occupies full-duplex time-domain resources and scenarios in which a channel or signal scheduled by the first DCI occupies non-full-duplex time-domain resources, which reduces the complexity of designing the cross-slot scheduling for full-duplex scenarios and makes the implementation easier.

In one embodiment, an advantage of the above method includes: avoiding the use of additional signaling to indicate the minimum scheduling offset value set to improve spectral efficiency and save signaling overhead.

According to one aspect of the present application, the above method is characterized in that the reference signal resource that is QCL with the physical layer channel scheduled by the first DCI belongs to a reference signal resource set among multiple reference signal resource sets; the reference signal resource set to which the reference signal resource that is QCL with the physical layer channel scheduled by the first DCI belongs is used to determine the minimum scheduling offset value set from the multiple candidate minimum scheduling offset value sets.

In one embodiment, characteristics of the above method include that the first DCI implicitly indicates a minimum scheduling offset value set, where the implicit indication includes indicating the minimum scheduling offset value set from the plurality of candidate minimum scheduling offset value sets based on a reference signal resource that is QCL with the physical layer channel scheduled by the first DCI.

In one embodiment, characteristics of the above method include that the first DCI implicitly indicates a minimum scheduling offset value set, where the implicit indication includes indicating the minimum scheduling offset value set from the plurality of candidate minimum scheduling offset value sets based on a reference signal resource set to which the reference signal resource that is QCL with the physical layer channel scheduled by the first DCI belongs.

In one embodiment, characteristics of the above method include that full-duplex symbols and non-full-duplex symbols may employ different panels/antennas, and based on the reference signal resource that is QCL with the physical layer channel scheduled by the first DCI the reference signal resource set may implicitly determine the type of the time-domain resource occupied by the physical layer channel scheduled by the first DCI, and thereby determine a corresponding minimum scheduling offset value set.

In one embodiment, an advantage of the above method includes that the reference signal resource that is QCL with the physical layer channel scheduled by the first DCI varies with different scenarios, which is beneficial to the adjustment of filtering parameters of the corresponding channel estimator and improves the transmission robustness.

In one embodiment, an advantage of the above method includes: avoiding the use of additional signaling to indicate the minimum scheduling offset value set to improve spectral efficiency and save signaling overhead.

According to one aspect of the present application, the above method is characterized in that the multiple candidate minimum scheduling offset value sets include a target candidate minimum scheduling offset value set, and at least one candidate minimum scheduling offset value of multiple candidate minimum scheduling offset values included in the target candidate minimum scheduling offset value set depends on a maximum number of transition points supported in a given time window.

In one embodiment, characteristics of the above method include that the given time window is equal to the duration of a plurality of consecutive slots.

In one embodiment, characteristics of the above method include that the given time window is a TDD UL/DL pattern period.

In one embodiment, characteristics of the above method include that the transition points include transition points between full-duplex symbols and non-full-duplex symbols and between non-full-duplex symbols and full-duplex symbols, the full-duplex symbols including SBFD symbols, and the non-full-duplex symbols including non-SBFD symbols.

In one embodiment, an advantage of the above method includes: striking a balance between transmission robustness and transmission delay.

In one embodiment, an advantage of the above method includes: reasonably configuring candidate minimum scheduling offsets according to the maximum number of transition points, avoiding the situation of failed data transmission caused by untimely buffering of the data channel due to the existence of a Guard Period between these transition points, and thus improving the transmission performance.

According to one aspect of the present application, the above method is characterized in that determining the minimum scheduling offset value set from the multiple candidate minimum scheduling offset value sets depends on the first DCI, the first DCI does not include a carrier indicator field, or a value of the carrier indicator field included in the first DCI is fixed.

In one embodiment, characteristics of the above method include that this application supports self-scheduling scenarios.

In one embodiment, an advantage of the above method includes: reducing system complexity and makes easier implementation possible.

According to one aspect of the present application, the above method is characterized in that the CORESET pool occupied by the first DCI is a first CORESET pool or a second CORESET pool, the first CORESET pool being used for scheduling in the first-type symbol set and the second CORESET pool being used for scheduling in symbols outside the first-type symbol set; or, the multiple reference signal resource sets are a first reference signal resource set and a second reference signal resource set, respectively, the first reference signal resource set being used for transmission in the first-type symbol set and the second reference signal resource set being used for transmission in symbols outside the first-type symbol set; the first-type symbol set includes symbols used for uplink transmission that are indicated as downlink symbols by TDD Uplink-Downlink (UL-DL) configuration.

In one embodiment, characteristics of the above method include that scheduling in the first-type symbol set and scheduling in symbols outside of the first-type symbol set correspond to different CORESET pools, respectively.

In one embodiment, characteristics of the above method include that transmissions in the first-type symbol set and transmissions in symbols outside of the first-type symbol set correspond to different reference signal resource sets, respectively.

In one embodiment, an advantage of the above method includes that a first CORESET pool and a second CORESET pool are for scheduling on full-duplex resources and scheduling on non-full-duplex resources, respectively, which reduces the design complexity of cross-slot scheduling in full-duplex scenarios and is easy to implement.

In one embodiment, an advantage of the above method includes that a first reference signal resource set and a second reference signal resource set are for scheduling on full-duplex resources and scheduling on non-full-duplex resources, respectively, which reduces the design complexity of cross-slot scheduling in full-duplex scenarios and is easy to implement.

According to one aspect of the present application, the above method is characterized in that the first node is a UE.

According to one aspect of the present application, the above method is characterized in that the first node is a relay node.

The present application provides a method in a second node for wireless communications, comprising:
transmitting a first DCI, the first DCI comprising a first field, the first field in the first DCI being used to indicate a minimum applicable scheduling offset;
herein, the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
   a resource occupied by the first DCI; or
   a time-domain resource occupied by a channel or signal scheduled by the first DCI; or
   a reference signal resource that is QCL with a physical layer channel scheduled by the first DCI.

According to one aspect of the present application, the above method is characterized in that the resource occupied by the first DCI includes a CORESET pool; the CORESET pool occupied by the first DCI is used to determine the minimum scheduling offset value set from the multiple candidate minimum scheduling offset value sets.

According to one aspect of the present application, the above method is characterized in that the multiple candidate minimum scheduling offset value sets are a first candidate minimum scheduling offset value set and a second candidate minimum scheduling offset value set, respectively; the time-domain resource occupied by the channel or the signal scheduled by the first DCI overlaps with a first-type symbol set, and the minimum scheduling offset value set is the first candidate minimum scheduling offset value set; the time-domain resource occupied by the channel or the signal scheduled by the first DCI is orthogonal to the first-type symbol set, and the minimum scheduling offset value set is the second candidate minimum scheduling offset value set.

According to one aspect of the present application, the above method is characterized in that the reference signal resource that is QCL with the physical layer channel scheduled by the first DCI belongs to a reference signal resource set among multiple reference signal resource sets; the reference signal resource set to which the reference signal resource that is QCL with the physical layer channel scheduled by the first DCI belongs is used to determine the minimum scheduling offset value set from the multiple candidate minimum scheduling offset value sets.

According to one aspect of the present application, the above method is characterized in that the multiple candidate minimum scheduling offset value sets include a target candidate minimum scheduling offset value set, and at least one candidate minimum scheduling offset value of multiple candidate minimum scheduling offset values included in the target candidate minimum scheduling offset value set depends on a maximum number of transition points supported in a given time window.

According to one aspect of the present application, the above method is characterized in that determining the minimum scheduling offset value set from the multiple candidate minimum scheduling offset value sets depends on the first DCI, the first DCI does not include a carrier indicator field, or a value of the carrier indicator field included in the first DCI is fixed.

According to one aspect of the present application, the above method is characterized in that the CORESET pool occupied by the first DCI is a first CORESET pool or a second CORESET pool, the first CORESET pool being used for scheduling in the first-type symbol set and the second CORESET pool being used for scheduling in symbols outside the first-type symbol set; or, the multiple reference signal resource sets are a first reference signal resource set and a second reference signal resource set, respectively, the first reference signal resource set being used for transmission in the first-type symbol set and the second reference signal resource set being used for transmission in symbols outside the first-type symbol set; the first-type symbol set includes symbols used for uplink transmission that are indicated as downlink symbols by TDD Uplink-Downlink (UL-DL) configuration.

According to one aspect of the present application, the above method is characterized in that the second node is a base station.

According to one aspect of the present application, the above method is characterized in that the second node is a UE.

According to one aspect of the present application, the above method is characterized in that the second node is a relay node.

The present application provides a first node for wireless communications, comprising:
a first receiver, receiving a first DCI, the first DCI comprising a first field, the first field in the first DCI being used to indicate a minimum applicable scheduling offset;
herein, the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
   a resource occupied by the first DCI; or
   a time-domain resource occupied by a channel or signal scheduled by the first DCI; or
   a reference signal resource that is QCL with a physical layer channel scheduled by the first DCI.

The present application provides a second node for wireless communications, comprising:
a first transmitter, transmitting a first DCI, the first DCI comprising a first field, the first field in the first DCI being used to indicate a minimum applicable scheduling offset;
herein, the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
   a resource occupied by the first DCI; or
   a time-domain resource occupied by a channel or signal scheduled by the first DCI; or
   a reference signal resource that is QCL with a physical layer channel scheduled by the first DCI.

In one embodiment, compared with the prior art, the present application is advantageous in, but not limited to, the following aspects:
configuring multiple minimum scheduling offset value sets, and adopting different minimum applicable scheduling offsets for different resources, providing better scheduling flexibility and resource allocation flexibility, and better adapting to cross-slot scheduling in different scenarios;
improving spectral efficiency and saving signaling overhead without the need to explicitly indicate the minimum scheduling offset value set;
reducing the design complexity of cross-slot scheduling in full-duplex scenarios, which is easy to realize.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of transmission of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of transmission between a first node and a second node according to one embodiment of the present application.

FIG. 6 illustrates a schematic diagram of a relationship between a resource occupied by a first DCI and a minimum scheduling offset value set according to one embodiment of the present application.

FIG. 7 illustrates a schematic diagram of a relationship between a CORESET pool occupied by a first DCI and a first symbol set according to one embodiment of the present application.

FIG. 8 illustrates a schematic diagram of a relationship between a channel or signal scheduled by a first DCI and a first-type symbol set according to one embodiment of the present application.

FIG. 9 illustrates a schematic diagram of a relationship between a minimum scheduling offset value set and a time-domain resource occupied by a channel or signal scheduled by a first DCI according to one embodiment of the present application.

FIG. 10 illustrates a schematic diagram of a relationship between a minimum scheduling offset value set and a reference signal resource that is QCL with a physical layer channel scheduled by a first DCI according to one embodiment of the present application.

FIG. 11 illustrates a schematic diagram of a relationship between multiple reference signal resource sets and a first-type symbol set according to one embodiment of the present application.

FIG. 12 illustrates a schematic diagram of a candidate minimum scheduling offset value according to one embodiment of the present application.

FIG. 13 illustrates a schematic diagram of a relationship between a first DCI and a minimum scheduling offset value set according to one embodiment of the present application.

FIG. 14 illustrates a schematic diagram of a first-type symbol set according to one embodiment of the present application.

FIG. 15 illustrates a structure block diagram of a processing device used in a first node according to one embodiment of the present application.

FIG. 16 illustrates a structure block diagram of a processing device used in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

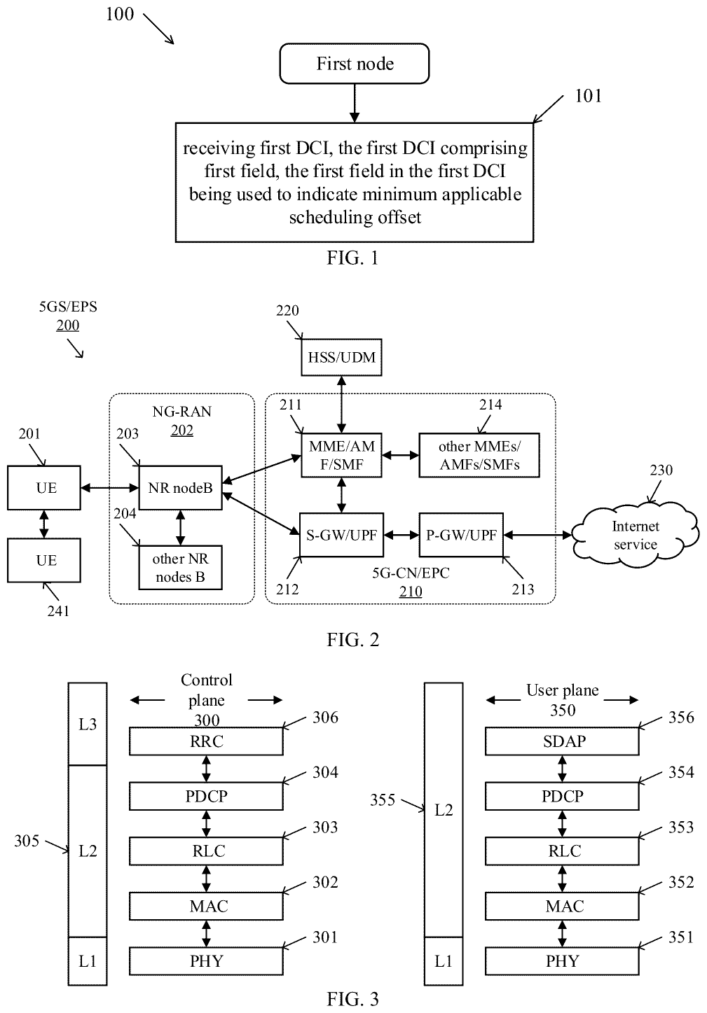

Embodiment 1 illustrates a flowchart of transmission of a first node according to one embodiment of the present application, as shown in FIG. 1. In FIG. 1, each box represents a step. Particularly, the sequential step arrangement in each box herein does not imply a chronological order of steps marked respectively by these boxes.

The first node receives a first DCI in step 101, the first DCI comprising a first field, the first field in the first DCI being used to indicate a minimum applicable scheduling offset.

In Embodiment 1, the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
a resource occupied by the first DCI; or
a time-domain resource occupied by a channel or signal scheduled by the first DCI; or
a reference signal resource that is QCL with a physical layer channel scheduled by the first DCI.

In one embodiment, the DCI refers to Downlink Control Information.

In one embodiment, the QCL refers to Quasi Co-Location.

In one embodiment, the QCL refers to being Quasi Co-Located.

In one embodiment, the first node receives the first DCI.

In one embodiment, the first DCI is an uplink scheduling signaling.

In one embodiment, the first DCI is used to schedule an uplink channel or an uplink signal.

In one embodiment, the format of the first DCI is a DCI format for scheduling uplink channels or uplink signals.

In one embodiment, the format of the first DCI is DCI format 0_X, X being a positive integer.

In one embodiment, the format of the first DCI is DCI format 0_1.

In one embodiment, the first DCI is a downlink scheduling signaling.

In one embodiment, the first DCI is used to schedule a downlink channel or a downlink signal.

In one embodiment, the format of the first DCI is a DCI format for scheduling downlink channels or downlink signals.

In one embodiment, the format of the first DCI is DCI format 1_X, X being a positive integer.

In one embodiment, the format of the first DCI is DCI format 1_1.

In one embodiment, the Cyclic Redundancy Check (CRC) of the first DCI is scrambled by a User Equipment-dedicated (UE-dedicated) Radio Network Temporary Identifier (RNTI).

In one embodiment, the first DCI comprises at least 1 DCI field.

In one embodiment, the first DCI comprises the first field.

In one embodiment, the first field included in the first DCI comprises at least 1 bit.

In one embodiment, the first field included in the first DCI comprises 1 bit.

In one embodiment, the first field included in the first DCI comprises at least log₂ K1 bits.

In one embodiment, the first field included in the first DCI comprises log₂ K1 bits.

In one embodiment, the first field included in the first DCI comprises a Minimum applicable scheduling offset indicator field.

In one embodiment, the first field included in the first DCI is a Minimum applicable scheduling offset indicator field.

In one embodiment, the minimum applicable scheduling offset is measured in the unit of slots.

In one embodiment, the minimum applicable scheduling offset is measured in the unit of symbols.

In one embodiment, the minimum applicable scheduling offset is measured in the unit of milliseconds (ms).

In one embodiment, the minimum applicable scheduling offset corresponds to K₀ₘᵢₙ in the 3rd Generation Partner Project Technical Specification 38 (3GPP TS 38) protocols.

In one embodiment, the minimum applicable scheduling offset corresponds to K₂ₘᵢₙ in the 3GPP TS 38 protocols.

In one embodiment, the minimum applicable scheduling offset corresponds to K₀ₘᵢₙ and K₂ₘᵢₙ in the 3GPP TS 38 protocols.

In one embodiment, the first field in the first DCI is used to indicate the minimum applicable scheduling offset.

In one embodiment, the first field in the first DCI implicitly indicates the minimum applicable scheduling offset.

In one embodiment, the implicit indication in this application includes indirectly indicating by means of indication of other IEs comprising a minimum applicable scheduling offset.

In one embodiment, the first field in the first DCI is used to indicate the minimum applicable scheduling offset in the minimum scheduling offset value set.

In one embodiment, the first field in the first DCI indicates the minimum applicable scheduling offset in the minimum scheduling offset value set.

In one embodiment, the first node is configured with the minimum scheduling offset value set.

In one embodiment, the first node is configured with the minimum scheduling offset value set on an active BandWidth Part (BWP).

In one embodiment, the minimum scheduling offset value set is configured per BWP.

In one embodiment, the first node is configured with the minimum scheduling offset value set on an active UpLink (UL) BWP, the first field of the first node indicating the minimum applicable scheduling offset in the minimum scheduling offset value set, the minimum applicable scheduling offset being applied to uplink scheduling.

In one embodiment, the first node is configured with the minimum scheduling offset value set on an active DownLink (DL) BWP, the first field of the first node indicating the minimum applicable scheduling offset in the minimum scheduling offset value set, the minimum applicable scheduling offset being applied to downlink scheduling.

In one embodiment, the first node is configured with the minimum scheduling offset value set respectively on an active UL BWP and an active DL BWP, and the first field of the first node indicates a minimum applicable scheduling offset from the minimum scheduling offset value set on the active UL BWP, the minimum applicable scheduling offset being applied to uplink scheduling; and, the first field of the first node indicates a minimum applicable scheduling offset from the minimum scheduling offset value set on the active DL BWP, the minimum applicable scheduling offset being applied to downlink scheduling.

In one subembodiment, the minimum scheduling offset value set on the active UL BWP is different from the minimum scheduling offset value set on the active DL BWP.

In one embodiment, the benefits of the above method include applicability to downlink and/or uplink cross-slot scheduling, reduction of terminal power consumption, and being energy efficient.

In one embodiment, the first node receives a second DCI, and the first node assumes that any scheduling delay between a channel or signal scheduled by the second DCI and the second DCI in any cell scheduled by the second DCI is no smaller than the minimum applicable scheduling offset, the second DCI being later than the first DCI.

In one embodiment, the minimum applicable scheduling offset is applied to an active BWP, the first node assumes that any scheduling delay from a channel or signal scheduled by a DCI on the active BWP to the DCI is no smaller than the minimum applicable scheduling offset before a new minimum applicable scheduling offset for the active BWP takes effect.

In one embodiment, the minimum applicable scheduling offset is applied to an active BWP, the first node assumes that any scheduling delay from a channel or signal scheduled by a DCI on the active BWP to the DCI is no smaller than the minimum applicable scheduling offset after the minimum applicable scheduling offset takes effect.

In one embodiment, “the minimum applicable scheduling offset being applied to uplink scheduling” in the present application means that the minimum applicable scheduling offset is applied to an active UL BWP, the first node assumes that any scheduling delay from a UL channel or UL signal scheduled by a DCI on the active UL BWP to the DCI is no smaller than the minimum applicable scheduling offset before a new minimum applicable scheduling offset for the active UL BWP takes effect.

In one embodiment, “the minimum applicable scheduling offset being applied to uplink scheduling” in the present application means that the minimum applicable scheduling offset is applied to an active UL BWP, the first node assumes that any scheduling delay from a UL channel or UL signal scheduled by a DCI on the active UL BWP to the DCI is no smaller than the minimum applicable scheduling offset after the minimum applicable scheduling offset takes effect.

In one embodiment, “the minimum applicable scheduling offset being applied to downlink scheduling” in the present application means that the minimum applicable scheduling offset is applied to an active DL BWP, the first node assumes that any scheduling delay from a DL channel or DL signal scheduled by a DCI on the active DL BWP to the DCI is no smaller than the minimum applicable scheduling offset before a new minimum applicable scheduling offset for the active DL BWP takes effect.

In one embodiment, “the minimum applicable scheduling offset being applied to downlink scheduling” in the present application means that the minimum applicable scheduling offset is applied to an active DL BWP, the first node assumes that any scheduling delay from a DL channel or DL signal scheduled by a DCI on the active DL BWP to the DCI is no smaller than the minimum applicable scheduling offset after the minimum applicable scheduling offset takes effect.

In one embodiment, K1 is a positive integer greater than 1.

In one embodiment, K1 is equal to 2.

In one embodiment, the K1 candidate minimum scheduling offset values are for uplink scheduling.

In one embodiment, the K1 candidate minimum scheduling offset values are for downlink scheduling.

In one embodiment, the first node is configured with different minimum scheduling offset value sets respectively on an active UL BWP and an active DL BWP, the minimum scheduling offset value set on the active UL BWP and the minimum scheduling offset value set on the active DL BWP each comprising K1 candidate minimum scheduling offset values.

In one embodiment, the minimum scheduling offset value set comprises 2 candidate minimum scheduling offset values.

In one embodiment, the first field in the first DCI is used to indicate the minimum applicable scheduling offset out of the K1 candidate minimum scheduling offset values.

In one embodiment, the first field in the first DCI indicates the minimum applicable scheduling offset out of the K1 candidate minimum scheduling offset values.

In one embodiment, the first node is configured with multiple candidate minimum scheduling offset value sets.

In one embodiment, the first node is configured with multiple candidate minimum scheduling offset value sets respectively on an active UL BWP and an active DL BWP.

In one embodiment, the multiple candidate minimum scheduling offset value sets are for downlink scheduling.

In one embodiment, the multiple candidate minimum scheduling offset value sets are for uplink scheduling.

In one embodiment, the first node is configured with multiple candidate minimum scheduling offset value sets respectively on an active UL BWP and an active DL BWP; the multiple candidate minimum scheduling offset value sets on the active UL BWP are all for uplink scheduling while the multiple candidate minimum scheduling offset value sets on the active DL BWP are all for downlink scheduling.

In one embodiment, the first node is configured with 2 candidate minimum scheduling offset value sets.

In one embodiment, the first node is configured with 2 candidate minimum scheduling offset value sets respectively on an active UL BWP and an active DL BWP.

In one embodiment, the first node is configured with 2 candidate minimum scheduling offset value sets respectively on an active UL BWP and an active DL BWP; the 2 candidate minimum scheduling offset value sets on the active UL BWP are all for uplink scheduling while the 2 candidate minimum scheduling offset value sets on the active DL BWP are all for downlink scheduling.

In one embodiment, any one of multiple candidate minimum scheduling offset value sets comprises at least 1 candidate minimum scheduling offset value.

In one embodiment, any one of multiple candidate minimum scheduling offset value sets comprises K1 candidate minimum scheduling offset values.

In one embodiment, the active BWP in this application means: the scheduled BWP of the first DCI.

In one embodiment, the active BWP in this application means: a BWP in a BWP pair to which the scheduled BWP of the first DCI belongs.

In one embodiment, the first DCI does not indicate the switching of an active BWP, and the active UL BWP and active DL BWP in the present application refer to a currently active UL BWP and a currently active DL BWP, respectively.

In one embodiment, the first DCI does not include a Bandwidth part indicator field, and the active UL BWP and active DL BWP in this application refer to a currently active UL BWP and a currently active DL BWP, respectively.

In one embodiment, the first DCI indicates the switching of an active BWP, and the active UL BWP and active DL BWP in the present application refer to a UL BWP and a DL BWP, respectively, as indicated by the first DCI.

In one embodiment, the first DCI comprises a Bandwidth part indicator field, and the active UL BWP and active DL BWP in this application refer to a UL BWP and a DL BWP indicated by the Bandwidth part indicator field of the first DCI, respectively.

In one embodiment, determining the minimum scheduling offset value set from the multiple candidate minimum scheduling offset value sets depends on a resource occupied by the first DCI.

In one embodiment, the resource occupied by the first DCI is used to determine the minimum scheduling offset value set from the multiple candidate minimum scheduling offset value sets.

In one embodiment, the resource occupied by the first DCI comprises a frequency-domain resource occupied by the first DCI.

In one subembodiment, the frequency-domain resource occupied by the first DCI comprises a sub-band occupied by the first DCI.

In one subembodiment, the frequency-domain resource occupied by the first DCI comprises a BandWidth (BWP) occupied by the first DCI.

In one subembodiment, the frequency-domain resource occupied by the first DCI comprises a carrier occupied by the first DCI.

In one subembodiment, the frequency-domain resource occupied by the first DCI comprises a serving cell occupied by the first DCI.

In one subembodiment, the frequency-domain resource occupied by the first DCI is used to determine the minimum scheduling offset value set from the multiple candidate minimum scheduling offset value sets.

In one embodiment, the resource occupied by the first DCI comprises a time-domain resource occupied by the first DCI.

In one subembodiment, the time-domain resource occupied by the first DCI comprises a symbol occupied by the first DCI.

In one subembodiment, the time-domain resource occupied by the first DCI comprises a slot occupied by the first DCI.

In one subembodiment, the time-domain resource occupied by the first DCI comprises a subframe occupied by the first DCI.

In one subembodiment, the time-domain resource occupied by the first DCI is used to determine the minimum scheduling offset value set from the multiple candidate minimum scheduling offset value sets.

In one embodiment, the symbol in the present application is a single-carrier symbol.

In one embodiment, the symbol in the present application is a multi-carrier symbol.

In one embodiment, the multi-carrier symbol in the present application is a Single Carrier-Frequency Division Multiple Access (SC-FDMA) symbol.

In one embodiment, the multi-carrier symbol in the present application is a Filter Bank Multi Carrier (FBMC) symbol.

In one embodiment, the multi-carrier symbol in the present application is an Orthogonal Frequency Division Multiplexing (OFDM) Symbol.

In one embodiment, the symbol in the present application is obtained by an output by transform precoding through OFDM Symbol Generation.

In one embodiment, the multi-carrier symbol in the present application is a Discrete Fourier Transform-spread-OFDM (DFT-s-OFDM) symbol.

In one embodiment, the multi-carrier symbol in the present application includes Cyclic Prefix-OFDM (CP-OFDM) symbol.

In one embodiment, the resource occupied by the first DCI comprises a spatial-domain resource occupied by the first DCI.

In one subembodiment, the spatial-domain resource occupied by the first DCI comprises a Transmission Configuration Indicator (TCI) employed by the first DCI.

In one subembodiment, the spatial-domain resource occupied by the first DCI comprises a reference signal resource that is QCL with a DeModulation Reference Signal (DMRS) included in the first DCI.

In one subembodiment, the spatial-domain resource occupied by the first DCI comprises a reference signal resource that is QCL with Resource Elements (REs) occupied by the first DCI.

In one subembodiment, the spatial-domain resource occupied by the first DCI is used to determine the minimum scheduling offset value set from the multiple candidate minimum scheduling offset value sets.

Typically, an RE occupies a symbol in the time domain and a subcarrier in the frequency domain.

In one embodiment, the resource occupied by the first DCI comprise a Physical Downlink Control CHannel (PDCCH) candidate occupied by the first DCI.

In one subembodiment, the PDCCH candidate occupied by the first DCI is used to determine the minimum scheduling offset value set from the multiple candidate minimum scheduling offset value sets.

In one embodiment, the resource occupied by the first DCI comprise a COntrol REsource SET (CORESET) pool in which REs occupied by the first DCI are located.

In one subembodiment, the CORESET pool occupied by the first DCI is used to determine the minimum scheduling offset value set from the multiple candidate minimum scheduling offset value sets.

In one embodiment, the resource occupied by the first DCI comprise a CORESET in which REs occupied by the first DCI are located.

In one subembodiment, the CORESET occupied by the first DCI is used to determine the minimum scheduling offset value set from the multiple candidate minimum scheduling offset value sets.

In one embodiment, the resource occupied by the first DCI comprise a Search Space Set (SS set) in which REs occupied by the first DCI are located.

In one subembodiment, the SS set occupied by the first DCI is used to determine the minimum scheduling offset value set from the multiple candidate minimum scheduling offset value sets.

In one embodiment, the resource occupied by the first DCI comprise a Search Space in which REs occupied by the first DCI are located.

In one subembodiment, the Search Space occupied by the first DCI is used to determine the minimum scheduling offset value set from the multiple candidate minimum scheduling offset value sets.

In one embodiment, determining the minimum scheduling offset value set from the multiple candidate minimum scheduling offset value sets depends on the time-domain resource occupied by a channel or signal scheduled by the first DCI.

In one embodiment, the time-domain resource occupied by a channel or signal scheduled by the first DCI is used to determine the minimum scheduling offset value set from the multiple candidate minimum scheduling offset value sets.

In one embodiment, determining the minimum scheduling offset value set from the multiple candidate minimum scheduling offset value sets depends on the time-domain resource occupied by a channel scheduled by the first DCI.

In one embodiment, the time-domain resource occupied by a channel scheduled by the first DCI is used to determine the minimum scheduling offset value set from the multiple candidate minimum scheduling offset value sets.

In one embodiment, a channel scheduled by the first DCI includes a Physical Downlink Shared Channel (PDSCH).

In one subembodiment, the time-domain resource occupied by the PDSCH scheduled by the first DCI is used to determine the minimum scheduling offset value set from the multiple candidate minimum scheduling offset value sets.

In one embodiment, a channel scheduled by the first DCI includes a Physical Uplink Shared CHannel (PUSCH).

In one subembodiment, the time-domain resource occupied by the PUSCH scheduled by the first DCI is used to determine the minimum scheduling offset value set from the multiple candidate minimum scheduling offset value sets.

In one embodiment, a time-domain resource occupied by a channel scheduled by the first DCI comprises a symbol occupied by the channel scheduled by the first DCI.

In one embodiment, a time-domain resource occupied by a channel scheduled by the first DCI comprises a slot occupied by the channel scheduled by the first DCI.

In one embodiment, a time-domain resource occupied by a channel scheduled by the first DCI comprises a subframe occupied by the channel scheduled by the first DCI.

In one embodiment, determining the minimum scheduling offset value set from the multiple candidate minimum scheduling offset value sets depends on the time-domain resource occupied by a signal scheduled by the first DCI.

In one embodiment, the time-domain resource occupied by a signal scheduled by the first DCI is used to determine the minimum scheduling offset value set from the multiple candidate minimum scheduling offset value sets.

In one embodiment, the signal scheduled by the first DCI includes a Channel State Information-Reference Signal (CSI-RS) triggered by the first DCI.

In one subembodiment, the first DCI comprises a CSI request field, the CSI request field being used to trigger the CSI-RS.

In one subembodiment, the time-domain resource occupied by the CSI-RS triggered by the first DCI is used to determine the minimum scheduling offset value set from the multiple candidate minimum scheduling offset value sets.

In one embodiment, the signal scheduled by the first DCI includes a Sounding Reference Signal (SRS) triggered by the first DCI.

In one subembodiment, the first DCI comprises an SRS request field, the SRS request field being used to trigger the SRS.

In one subembodiment, the time-domain resource occupied by the SRS triggered by the first DCI is used to determine the minimum scheduling offset value set from the multiple candidate minimum scheduling offset value sets.

In one embodiment, a time-domain resource occupied by a signal scheduled by the first DCI comprises a symbol occupied by the signal scheduled by the first DCI.

In one embodiment, a time-domain resource occupied by a signal scheduled by the first DCI comprises a slot occupied by the signal scheduled by the first DCI.

In one embodiment, a time-domain resource occupied by a signal scheduled by the first DCI comprises a subframe occupied by the signal scheduled by the first DCI.

In one embodiment, determining the minimum scheduling offset value set from the multiple candidate minimum scheduling offset value sets depends on a reference signal resource that is QCL with a physical layer channel scheduled by the first DCI.

In one embodiment, a reference signal resource that is QCL with a physical layer channel scheduled by the first DCI is used to determine the minimum scheduling offset value set from the multiple candidate minimum scheduling offset value sets.

In one embodiment, the QCL comprises a QCL parameter.

In one embodiment, the QCL comprises a QCL assumption.

In one embodiment, the QCL type includes TypeA, TypeB, TypeC and TypeD.

In one embodiment, a QCL parameter of QCL-TypeA includes a Doppler shift, a Doppler spread, an average delay, and a delay spread.

In one embodiment, a QCL parameter of QCL-TypeB includes a Doppler shift and a Doppler spread.

In one embodiment, a QCL parameter of QCL-TypeC includes a Doppler shift and an average delay.

In one embodiment, a QCL parameter of QCL-TypeD includes a spatial Rx parameter.

In one embodiment, the QCL includes at least one of a Doppler shift, a Doppler spread, an average delay, a delay spread, a Spatial Tx parameter or a Spatial Rx parameter.

In one embodiment, for detailed meaning of the TypeA, the TypeB, the TypeC and the TypeD, refer to 3GPP TS 38.214, Section 5.1.5.

In one embodiment, the reference signal resource that is QCL with the physical layer channel scheduled by the first DCI comprises a CSI-RS resource.

In one embodiment, the reference signal resource that is QCL with the physical layer channel scheduled by the first DCI is a CSI-RS resource.

In one embodiment, the reference signal resource that is QCL with the physical layer channel scheduled by the first DCI is a non-zero-power (NZP) CSI-RS resource.

In one embodiment, the reference signal resource that is QCL with the physical layer channel scheduled by the first DCI is a Tracking Reference Signal (TRS) resource.

In one embodiment, the reference signal resource that is QCL with the physical layer channel scheduled by the first DCI is an SRS resource.

In one embodiment, the reference signal resource that is QCL with the physical layer channel scheduled by the first DCI comprises an SSB.

In one embodiment, the reference signal resource that is QCL with the physical layer channel scheduled by the first DCI is an SSB.

In one embodiment, the SSB in this application refers to: SS/PBCH block.

In one embodiment, the SSB in this application refers to: Synchronisation Signal/Physical Broadcast CHannel block.

Typically, the reception occasion of Physical Broadcast CHannel (PBCH), Primary Synchronization Signal (PSS) and Secondary Synchronization Signal (SSS) lies in consecutive symbols and forms an SS/PBCH block.

In one embodiment, the reference signal resource that is QCL with the physical layer channel scheduled by the first DCI comprises one or more ports.

In one subembodiment, the one or more ports comprised in the reference signal resource that is QCL with the physical layer channel scheduled by the first DCI is/are respectively CSI-RS port(s).

In one subembodiment, the one or more ports comprised in the reference signal resource that is QCL with the physical layer channel scheduled by the first DCI is/are respectively antenna port(s).

In one embodiment, the reference signal resource that is QCL with the physical layer channel scheduled by the first DCI comprises a reference signal.

In one embodiment, the reference signal resource that is QCL with the physical layer channel scheduled by the first DCI comprises a reference signal transmitted in the reference signal resource.

In one embodiment, the reference signal resource that is QCL with the physical layer channel scheduled by the first DCI corresponds to a TCI.

In one embodiment, the reference signal resource that is QCL with the physical layer channel scheduled by the first DCI corresponds to an SRS Resource Indicator (SRI).

In one embodiment, the feature “a reference signal resource that is QCL with a physical layer channel scheduled by the first DCI” means: a reference signal resource that is QCL with a DMRS port of the physical layer channel scheduled by the first DCI.

In one embodiment, the feature “a reference signal resource that is QCL with a physical layer channel scheduled by the first DCI” means: all reference signal resources that are QCL with a DMRS port of the physical layer channel scheduled by the first DCI.

In one embodiment, the feature “a reference signal resource that is QCL with a physical layer channel scheduled by the first DCI” means: any reference signal resource that is QCL with a DMRS port of the physical layer channel scheduled by the first DCI.

In one embodiment, the feature “a reference signal resource that is QCL with a physical layer channel scheduled by the first DCI” means: a reference signal resource that is QCL with an antenna port of the physical layer channel scheduled by the first DCI.

In one embodiment, the feature “a reference signal resource that is QCL with a physical layer channel scheduled by the first DCI” means: all reference signal resources that are QCL with an antenna port of the physical layer channel scheduled by the first DCI.

In one embodiment, the feature “a reference signal resource that is QCL with a physical layer channel scheduled by the first DCI” means: any reference signal resource that is QCL with an antenna port of the physical layer channel scheduled by the first DCI.

In one embodiment, the feature “a reference signal resource that is QCL with a physical layer channel scheduled by the first DCI” means: a reference signal resource that is QCL with REs of the physical layer channel scheduled by the first DCI.

In one embodiment, the feature “a reference signal resource that is QCL with a physical layer channel scheduled by the first DCI” means: all reference signal resources that are QCL with REs of the physical layer channel scheduled by the first DCI.

In one embodiment, the feature “a reference signal resource that is QCL with a physical layer channel scheduled by the first DCI” means: any reference signal resource that is QCL with REs of the physical layer channel scheduled by the first DCI.

In one embodiment, the physical layer channel scheduled by the first DCI is a physical layer downlink channel, and the reference signal resource that is QCL with the physical layer channel scheduled by the first DCI is a downlink reference signal resource, the first node assumes that the same QCL parameters are used for both receiving the physical layer channel scheduled by the first DCI and receiving the reference signal resource that is QCL with the physical layer channel scheduled by the first DCI.

In one embodiment, the physical layer channel scheduled by the first DCI is a physical layer downlink channel, and the reference signal resource that is QCL with the physical layer channel scheduled by the first DCI is an uplink reference signal resource, the first node assumes that the same QCL parameters are used for both receiving the physical layer channel scheduled by the first DCI and transmitting the reference signal resource that is QCL with the physical layer channel scheduled by the first DCI.

In one embodiment, the physical layer channel scheduled by the first DCI is a physical layer uplink channel, and the reference signal resource that is QCL with the physical layer channel scheduled by the first DCI is a downlink reference signal resource, the first node assumes that the same QCL parameters are used for both transmitting the physical layer channel scheduled by the first DCI and receiving the reference signal resource that is QCL with the physical layer channel scheduled by the first DCI.

In one embodiment, the physical layer channel scheduled by the first DCI is a physical layer uplink channel, and the reference signal resource that is QCL with the physical layer channel scheduled by the first DCI is an uplink reference signal resource, the first node assumes that the same QCL parameters are used for both transmitting the physical layer channel scheduled by the first DCI and transmitting the reference signal resource that is QCL with the physical layer channel scheduled by the first DCI.

### Embodiment 2

Embodiment 2 illustrates a schematic diagram of a network architecture according to one embodiment of the present application, as shown in FIG. 2.

FIG. 2 illustrates a network architecture of Long-Term Evolution (LTE), Long-Term Evolution Advanced (LTE-A) and future 5G systems. The network architecture of the LTE, LTE-A and future 5G systems may be called an Evolved Packet System (EPS). The 5G NR or LTE network architecture may be referred to as 5G System (5GS)/EPS 200 or some other suitable terminology. The 5GS/EPS 200 may comprise one or more UEs 201, a UE 241 in sidelink communication with the UE(s) 201, an NG-RAN 202, a 5G Core Network/Evolved Packet Core (5G-CN/EPC) 210, a Home Subscriber Server/Unified Data Management (HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services. The NG-RAN 202 comprises an NR node B (gNB) 203 and other gNBs 204. The gNB 203 provides UE 201-oriented user plane and control plane terminations. The gNB 203 can be connected to other gNBs 204 via an Xn interface (like backhaul). The gNB 203 may be called a base station, a base transceiver station, a radio base station, a radio transceiver, a transceiver function, a Basic Service Set (BSS), an Extended Service Set (ESS), a Transmission and Reception Point (TRP) or some other applicable terms. The gNB 203 provides an access point of the 5G-CN/EPC 210 for the UE 201. Examples of UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5G-CN/EPC 210 via an Sl/NG interface. The 5G-CN/EPC 210 comprises a Mobility Management Entity (MME)/Authentication Management Field (AMF)/Session Management Function (SMF) 211, other MMEs/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5G-CN/EPC 210. Generally, the MME/AMF/SMF 211 provides bearer and connection management. All user Internet Protocol (IP) packets are transmitted through the S-GW/UPF 212. The S-GW/UPF 212 itself is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and packet switching (PS) services.

In one embodiment, the first node in the present application includes the UE 201.

In one embodiment, the second node in the present application includes the gNB203.

In one embodiment, the UE 201 includes cellphone.

In one embodiment, the UE 201 is a means of transportation including automobile.

In one embodiment, the gNB 203 is a Macro Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station supporting large time-delay difference.

In one embodiment, the gNB203 is a flight platform.

In one embodiment, the gNB203 is satellite equipment.

In one embodiment, the gNB 203 is a piece of test equipment (e.g., a transceiving device simulating partial functions of the base station, or a signaling test instrument).

In one embodiment, a radio link from the UE 201 to the gNB 203 is an uplink, the uplink being used for performing uplink transmission.

In one embodiment, a radio link from the gNB 203 to the UE 201 is a downlink, the downlink being used for performing downlink transmission.

In one embodiment, a radio link between the UE201 and the gNB203 includes a cellular link.

In one embodiment, the UE 201 and the gNB 203 are connected to each other via a Uu air interface.

In one embodiment, a transmitter of the first DCI includes the gNB 203.

In one embodiment, a receiver of the first DCI includes the UE 201.

In one embodiment, the UE 201 supports downlink cross-slot scheduling.

In one embodiment, the UE 201 supports uplink cross-slot scheduling.

In one embodiment, the gNB 203 supports downlink cross-slot scheduling.

In one embodiment, the gNB 203 supports uplink cross-slot scheduling.

In one embodiment, the UE 201 supports SubBand non-overlapping Full Duplex (SBFD).

In one embodiment, the UE 201 supports a more flexible duplex mode or full duplex mode.

In one embodiment, the gNB 203 supports SBFD.

In one embodiment, the gNB 203 supports a more flexible duplex mode or full duplex mode.

### Embodiment 3

Embodiment 3 illustrates a schematic diagram of an example of a radio protocol architecture of a user plane and a control plane according to the present application, as shown in FIG. 3.

FIG. 3 is a schematic diagram illustrating an embodiment of a radio protocol architecture of a user plane 350 and a control plane 300. In FIG. 3, the radio protocol architecture for a control plane 300 between a first communication node (UE, or Road Side Unit/RSU in Vehicle to Everything(V2X), vehicle-mounted equipment or vehicle-mounted communication module) and a second node (gNB, UE, or RSU in V2X, vehicle-mounted equipment or vehicle-mounted communication module), or between two UEs is represented by three layers, i.e., Layer 1 (L1), Layer 2 (L2) and Layer 3 (L3). The L1 is the lowest layer which performs various signal processing functions of PHY (i.e., PHYsical layer). The L1 is called PHY 301 in the present application. The L2 305 is above the PHY 301, and is in charge of the link between a first node and a second node as well as between two UEs via the PHY 301. The 12 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., Internet Protocol/IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first DCI is generated by the PHY 301 or the PHY 351.

### Embodiment 4

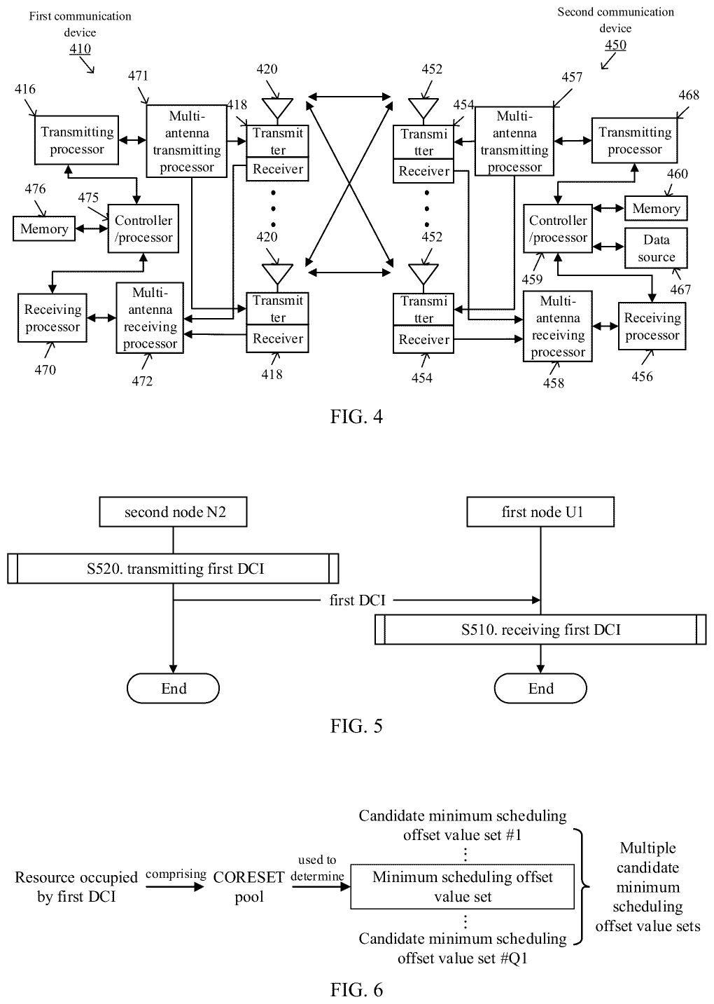

Embodiment 4 illustrates a schematic diagram of a first communication device and a second communication device according to one embodiment of the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In DL, the controller/processor 475 provides header compression, encryption, packet segmentation and reordering, multiplexing between a logical channel and a transport channel and radio resource allocation of the second communication device 450 based on various priorities. The controller/processor 475 is responsible for HARQ operation, retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 and the mapping of signal clusters corresponding to each modulation scheme (i.e., Binary Phase Shift Keying (BPSK), Quadrature Phase Shift Keying (QPSK), M-PSK, and M-Quadrature Amplitude Modulation (M-QAM), etc.). The multi-antenna transmitting processor 471 performs digital spatial precoding, which includes precoding based on codebook and precoding based on non-codebook, and beamforming processing on encoded and modulated signals to generate one or more parallel streams. The transmitting processor 416 then maps each parallel stream to a subcarrier. The modulated symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna. Each receiver 454 recovers information modulated to the RF carrier, and converts the radio frequency stream into a baseband multicarrier symbol stream to be provided to the receiving processor 456. The receiving processor 456 and the multi-antenna receiving processor 458 provide various signal processing functions of the L1. The multi-antenna receiving processor 458 performs reception analog precoding/beamforming on a baseband multicarrier symbol stream provided by the receiver 454. The receiving processor 456 converts the processed baseband multicarrier symbol stream from time domain into frequency domain using Fast Fourier Transform (FFT). In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any second communication device 450-targeted parallel stream. Symbols on each parallel stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2. The controller/processor 459 can be associated with a memory 460 that stores program code and data. The memory 460 can be called a computer readable medium. In DL transmission, the controller/processor 459 provides de-multiplexing between a transport channel and a logical channel, packet reassembling, decryption, header decompression, control signal processing so as to recover a higher-layer packet from the core network. The higher-layer packet is later provided to all protocol layers above the L2. Or various control signals can be provided to the L3 for processing. The controller/processor 459 also performs error detection using ACKnowledgement (ACK) and/or Negative ACKnowledgement (NACK) protocols as a way to support HARQ operation.

In a transmission from the second communication device 450 to the first communication device 410, at the second communication device 450, the data source 467 is used to provide a higher layer packet to the controller/processor 459. The data source 467 represents all protocol layers above the L2. Similar to a transmitting function of the first communication device 410 described in DL, the controller/processor 459 performs header compression, encryption, packet segmentation and reordering, and multiplexing between a logical channel and a transport channel based on radio resource allocation for the first communication device 410 so as to provide the L2 functions used for the user plane and the control plane. The controller/processor 459 is responsible for HARQ operation, retransmission of a lost packet and a signaling to the first communication device 410. The transmitting processor 468 performs modulation and mapping, as well as channel coding, and the multi-antenna transmitting processor 457 performs digital multi-antenna spatial precoding, including codebook-based precoding and non-codebook-based precoding, and beamforming. The transmitting processor 468 then modulates generated parallel streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1. The controller/processor 475 provides functions of the L2. The controller/processor 475 can be associated with the memory 476 that stores program code and data. The memory 476 can be called a computer readable medium. The controller/processor 475 provides demultiplexing between a transport channel and a logical channel, packet reassembling, decryption, header decompression and control signal processing so as to recover a higher-layer packet from the second communication device 450. The higher-layer packet coming from the controller/processor 475 may be provided to the core network. The controller/processor 475 can also perform error detection using ACK and/or NACK protocol to support HARQ operation.

In one embodiment, the second communication device 450 comprises at least one processor and at least one memory. The at least one memory comprises computer program codes; the at least one memory and the computer program codes are configured to be used in collaboration with the at least one processor. The second communication device 450 at least receives a first DCI, the first DCI comprising a first field, the first field in the first DCI being used to indicate a minimum applicable scheduling offset; the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
a resource occupied by the first DCI; or
a time-domain resource occupied by a channel or signal scheduled by the first DCI; or
a reference signal resource that is QCL with a physical layer channel scheduled by the first DCI.

In one embodiment, the second communication device 450 comprises a memory that stores a computer readable instruction program. The computer readable instruction program generates actions when executed by at least one processor. The actions include: receiving a first DCI.

In one embodiment, the first communication device 410 comprises at least one processor and at least one memory. The at least one memory comprises computer program codes; the at least one memory and the computer program codes are configured to be used in collaboration with the at least one processor. The first communication device 410 at least transmits a first DCI, the first DCI comprising a first field, the first field in the first DCI being used to indicate a minimum applicable scheduling offset; the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
a resource occupied by the first DCI; or
a time-domain resource occupied by a channel or signal scheduled by the first DCI; or
a reference signal resource that is QCL with a physical layer channel scheduled by the first DCI.

In one embodiment, the first communication device 410 comprises a memory that stores a computer readable instruction program. The computer readable instruction program generates actions when executed by at least one processor. The actions include: transmitting a first DCI.

In one embodiment, the first node in the present application comprises the second communication device 450.

In one embodiment, the second node in the present application comprises the first communication device 410.

In one embodiment, at least one of the antenna 420, the transmitter 418, the transmitting processor 416, the multi-antenna transmitting processor 471, the controller/processor 475 or the memory 476 is used for transmitting the first DCI; at least one of the antenna 452, the receiver 454, the receiving processor 456, the multi-antenna receiving processor 458, the controller/processor 459, the memory 460 or the data source 467 is used for receiving the first DCI.

### Embodiment 5

Embodiment 5 illustrates a flowchart of transmission between a first node and a second node according to one embodiment of the present application. In FIG. 5, a first node U1 and a second node N2 are in communication via a radio link. It should be particularly noted that the sequence illustrated herein does not set any limit to the signal transmission order or implementation order in the present application;

The first node U1 receives a first DCI in step S510.

The second node N2 transmits a first DCI in step S520.

In Embodiment 5, the first DCI comprises a first field, the first field in the first DCI being used to indicate a minimum applicable scheduling offset; the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
a resource occupied by the first DCI; or
a time-domain resource occupied by a channel or signal scheduled by the first DCI; or
a reference signal resource that is QCL with a physical layer channel scheduled by the first DCI.

In one embodiment, the first node U1 is the first node in the present application.

In one embodiment, the second node N2 is the second node in the present application.

In one embodiment, an air interface between the second node N2 and the first node U1 includes a radio interface between a base station and a UE.

In one embodiment, an air interface between the second node N2 and the first node U1 includes a radio interface between a relay node and a UE.

In one embodiment, an air interface between the second node N2 and the first node U1 includes a radio interface between a UE and another UE.

In one embodiment, the second node N2 is a maintenance base station for a serving cell of the first node U1.

In one embodiment, the first DCI is transmitted on a downlink physical control channel (i.e., a downlink channel only capable of bearing physical layer signaling).

In one embodiment, a physical layer channel occupied by the first DCI includes a PDCCH.

In one embodiment, a physical layer channel scheduled by the first DCI includes a PDSCH.

In one embodiment, a physical layer channel scheduled by the first DCI includes a PUSCH.

### Embodiment 6

Embodiment 6 illustrates a schematic diagram of a relationship between a resource occupied by a first DCI and a minimum scheduling offset value set according to one embodiment of the present application, as shown in FIG. 6. In FIG. 6, the resource occupied by the first DCI includes a CORESET pool; the CORESET pool occupied by the first DCI is used to determine the minimum scheduling offset value set from the multiple candidate minimum scheduling offset value sets; the multiple candidate minimum scheduling offset value sets are represented in FIG. 6 of the accompanying drawings as {candidate minimum scheduling offset value set #1, . . . , minimum scheduling offset value set, . . . , candidate minimum scheduling offset value set #Q1}, Q1 being a positive integer greater than 1.

In one embodiment, the resource occupied by the first DCI includes a CORESET pool; the CORESET pool occupied by the first DCI is used to determine the minimum scheduling offset value set from the multiple candidate minimum scheduling offset value sets.

In one embodiment, the feature “the resource occupied by the first DCI includes a CORESET pool” means that the physical layer channel occupied by the first DCI includes a PDCCH, a CORESET to which the PDCCH belongs belonging to a CORESET pool.

In one embodiment, the feature “the resource occupied by the first DCI includes a CORESET pool” means that the physical layer channel occupied by the first DCI includes a PDCCH, a CORESET associated with a search space to which the PDCCH belongs belonging to a CORESET pool.

In one embodiment, the multiple candidate minimum scheduling offset value sets are for downlink scheduling.

In one embodiment, the multiple candidate minimum scheduling offset value sets are for uplink scheduling.

In one embodiment, the multiple candidate minimum scheduling offset value sets are a first candidate minimum scheduling offset value set and a second candidate minimum scheduling offset value set, Q1 being equal to 2; the first DCI occupies a first CORESET pool, and the minimum scheduling offset value set is the first candidate minimum scheduling offset value set; the first DCI occupies a second CORESET pool, and the minimum scheduling offset value set is the second candidate minimum scheduling offset value set; the first CORESET pool is different from the second CORESET pool.

In one subembodiment, the first node is configured with the 2 candidate minimum scheduling offset value sets respectively on an active UL BWP and an active DL BWP, the 2 candidate minimum scheduling offset value sets on the active UL BWP being different from the 2 candidate minimum scheduling offset value sets on the active DL BWP; the first DCI occupies a first CORESET pool, the minimum scheduling offset value set applied to uplink scheduling is a first candidate minimum scheduling offset value set on the active UL BWP of the first node and the minimum scheduling offset value set applied to downlink scheduling is a first candidate minimum scheduling offset value set on the active DL BWP of the first node; the first DCI occupies a second CORESET pool, the minimum scheduling offset value set applied to uplink scheduling is a second candidate minimum scheduling offset value set on the active UL BWP of the first node and the minimum scheduling offset value set applied to downlink scheduling is a second candidate minimum scheduling offset value set on the active DL BWP of the first node.

In one subsidiary embodiment of the above subembodiment, the minimum scheduling offset value set applied to the uplink is different from the minimum scheduling offset value set applied to the downlink.

In one subembodiment, the CORESETs in the first CORESET pool are configured to be used for scheduling in SBFD resources.

In one subembodiment, the CORESETs in the second CORESET pool are used for configuring scheduling in resources other than those for SBFD.

In one subembodiment, the first CORESET pool and the second CORESET pool correspond to two different coresetPoolIndexes, respectively.

In one subembodiment, the first CORESET pool and the second CORESET pool correspond to two different Transmission and Reception Points (TRPs), respectively.

In one subembodiment, the first CORESET pool and the second CORESET pool correspond to a PCI and an AdditionalPCI, respectively.

In one subembodiment, the first CORESET pool and the second CORESET pool correspond to two different PCIs, respectively.

In one embodiment, the multiple candidate minimum scheduling offset value sets are respectively Q1 candidate minimum scheduling offset value sets, Q1 being a positive integer greater than 2; the Q1 candidate minimum scheduling offset value sets respectively correspond to Q1 CORESET pools, the first DCI occupying a given CORESET pool among the Q1 CORESET pools, the given CORESET pool corresponding to the minimum scheduling offset value set of the Q1 candidate minimum scheduling offset value sets; the given CORESET pool occupied by the first DCI is used to determine the minimum scheduling offset value set from the Q1 candidate minimum scheduling offset value sets.

In one subembodiment, the first node is configured with Q1 candidate minimum scheduling offset value sets respectively on an active UL BWP and an active DL BWP, the Q1 candidate minimum scheduling offset value sets on the active UL BWP being different from the Q1 candidate minimum scheduling offset value sets on the active DL BWP; the given CORESET pool occupied by the first DCI is used to determine a minimum scheduling offset value set applicable for uplink from the Q1 candidate minimum scheduling offset value sets on the active UL BWP and to determine a minimum scheduling offset value set applicable for downlink from the Q1 candidate minimum scheduling offset value sets on the active DL BWP.

In one subembodiment, there is at least one of the Q1 CORESET pools being configured for scheduling in SBFD resources.

In one subembodiment, the Q1 CORESET pools correspond to Q1 different CORESETPoollndexes, respectively.

In one subembodiment, the Q1 CORESET pools correspond to Q1 TRPs, respectively.

In one subembodiment, the Q1 CORESET pools correspond to Q1 PCIs, respectively.

In one embodiment, the meaning of a CORESET pool occupied by the first DCI comprises: a CORESET pool to which the CORESET where REs occupied by the first DCI are present belongs.

In one embodiment, the meaning of a CORESET pool occupied by the first DCI comprises: a CORESET pool to which the CORESET associated with a Search Space in which a PDCCH Candidate occupied by the first DCI is present belongs.

In one embodiment, a PCI identifies a cell.

In one embodiment, the PCI in this application refers to: Physical Cell Identifier.

In one embodiment, the PCI in this application refers to: Physical Cell Identity.

In one embodiment, the PCI in this application refers to: Physical-layer Cell Identity.

In one embodiment, the PCI in this application refers to: PhysCellId.

In one embodiment, the PCI in this application is a non-negative integer.

In one embodiment, the PCI in this application is a non-negative integer no greater than 1007.

In one embodiment, a cell identified by the AdditionalPCI in this application is not a serving cell.

In one embodiment, a cell identified by the AdditionalPCI in this application is a cell used for inter-cell mobility.

In one embodiment, a cell identified by the AdditionalPCI in this application is a cell used for inter-cell beam management.

In one embodiment, a cell identified by the AdditionalPCI in this application is a cell used for Layer 1/Layer 2 (L1/L2) inter-cell mobility.

In one embodiment, a cell identified by the AdditionalPCI in this application is a cell used for L1/L2 inter-cell beam management.

In one embodiment, the SBFD resources in the present application comprise: symbols that are configured as downlink symbols by TDD uplink-downlink configuration signaling and used for uplink transmission.

In one embodiment, the SBFD resources in the present application comprise: symbols that are configured as flexible symbols by the TDD uplink-downlink configuration signaling and used for uplink transmission.

In one embodiment, the SBFD resources in the present application comprise the first-type symbols in Embodiment 14 of the present application.

In one embodiment, the resources for SBFD in the present application comprise: a subband configured for uplink transmission in a DL BWP.

In one embodiment, the resources for SBFD in the present application comprise: a frequency-domain resource configured for uplink transmission in a DL carrier.

In one embodiment, the resources for SBFD in the present application comprise: the first sub-band in Embodiment 14 of the present application.

### Embodiment 7

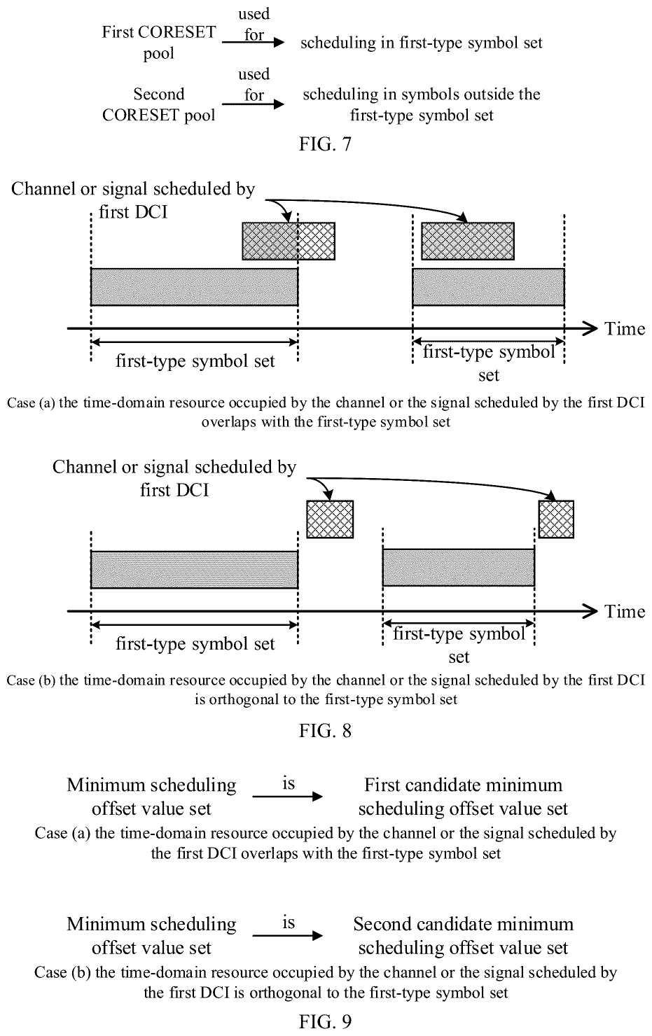

Embodiment 7 illustrates a schematic diagram of a relationship between a CORESET pool occupied by a first DCI and a first symbol set according to one embodiment of the present application, as shown in FIG. 7. In FIG. 7, a first CORESET pool is used for scheduling in a first-type symbol set; a second CORESET pool is used for scheduling in symbols outside the first-type symbol set.

In Embodiment 7, a CORESET pool occupied by the first DCI is the first CORESET pool or the second CORESET pool; the first-type symbol set includes symbols used for uplink transmission that are indicated as downlink symbols by TDD UL-DL configuration.

In one embodiment, the CORESET pool occupied by the first DCI is the first CORESET pool or the second CORESET pool; the first CORESET pool is used for scheduling in a first-type symbol set; the second CORESET pool is used for scheduling in symbols outside the first-type symbol set; the first-type symbol set includes symbols used for uplink transmission that are indicated as downlink symbols by TDD UL-DL configuration.

In one embodiment, a time-domain resource occupied by a channel or signal scheduled by a DCI of any CORESET in the first-type CORESET pool overlaps with the first-type symbol set; a time-domain resource occupied by a channel or signal scheduled by a DCI of any CORESET in the second-type CORESET pool is orthogonal to the first-type symbol set.

In one embodiment, a time-domain resource occupied by a channel or signal scheduled by a DCI of any CORESET in the first-type CORESET pool belongs to the first-type symbol set; a time-domain resource occupied by a channel or signal scheduled by a DCI of any CORESET in the second-type CORESET pool belongs to symbols outside the first-type symbol set.

In one embodiment, the first-type symbol set includes the first-type symbols of Embodiment 14 of the present application.

### Embodiment 8

Embodiment 8 illustrates a schematic diagram of a relationship between a channel or signal scheduled by a first DCI and a first-type symbol set according to one embodiment of the present application, as shown in FIG. 8. In FIG. 8, the horizontal axis represents time; the gray-filled area represents in time the time-domain resource occupied by the first-type symbol set; and the cross-filled area represents in time the time-domain resource occupied by the channel or signal scheduled by the first DCI, where the gray cross-filled area represents in time the time-domain resource in which the channel or signal scheduled by the first DCI overlaps with the first-type symbol set.

In Embodiment 8, Case (a) denotes that the time-domain resource occupied by the channel or the signal scheduled by the first DCI overlaps with the first-type symbol set; Case (b) denotes that the time-domain resource occupied by the channel or the signal scheduled by the first DCI is orthogonal to the first-type symbol set.

In one embodiment, the time-domain resource occupied by a channel or signal scheduled by the first DCI is contiguous.

In one embodiment, the time-domain resource occupied by a channel or signal scheduled by the first DCI is not contiguous.

In one embodiment, the time-domain resource occupied by a channel or signal scheduled by the first DCI is periodical.

In one embodiment, the first-type symbol set includes at least one symbol.

In one embodiment, the first-type symbol set includes 1 symbol.

In one embodiment, the first-type symbol set includes multiple consecutive symbols.

In one embodiment, the first-type symbol set includes multiple symbols, and there are two symbols being non-consecutive among the multiple symbols.

In one embodiment, the first-type symbol set includes multiple symbols, and the multiple symbols are periodical in time domain.

In one embodiment, the feature “the time-domain resource occupied by the channel or the signal scheduled by the first DCI overlaps with the first-type symbol set” means that at least 1 symbol occupied by the channel or signal scheduled by the first DCI belongs to the first-type symbol set.

In one embodiment, the feature “the time-domain resource occupied by the channel or the signal scheduled by the first DCI overlaps with the first-type symbol set” means that each symbol occupied by the channel or signal scheduled by the first DCI belongs to the first-type symbol set.

In one embodiment, the feature “the time-domain resource occupied by the channel or the signal scheduled by the first DCI overlaps with the first-type symbol set” means that 1 symbol of all symbols occupied by the channel or signal scheduled by the first DCI does not belong to the first-type symbol set.

In one embodiment, the feature “the time-domain resource occupied by the channel or the signal scheduled by the first DCI overlaps with the first-type symbol set” means that at least 1 symbol of all symbols occupied by the channel or signal scheduled by the first DCI belongs to the first-type symbol set, and at least 1 symbol of all symbols occupied by the channel or signal scheduled by the first DCI does not belong to the first-type symbol set.

In one embodiment, the feature “the time-domain resource occupied by the channel or the signal scheduled by the first DCI overlaps with the first-type symbol set” means that the first-type symbol set includes at least 1 symbol occupied by the channel or signal scheduled by the first DCI.

In one embodiment, the feature “the time-domain resource occupied by the channel or the signal scheduled by the first DCI overlaps with the first-type symbol set” means that the first-type symbol set includes all symbols occupied by the channel or signal scheduled by the first DCI.

In one embodiment, the feature “the time-domain resource occupied by the channel or the signal scheduled by the first DCI is orthogonal to the first-type symbol set” means that none of symbols occupied by the channel or signal scheduled by the first DCI overlaps with the first-type symbol set in time domain.

In one embodiment, the feature “the time-domain resource occupied by the channel or the signal scheduled by the first DCI is orthogonal to the first-type symbol set” means that none of symbols occupied by the channel or signal scheduled by the first DCI belongs to the first-type symbol set.

In one embodiment, the feature “the time-domain resource occupied by the channel or the signal scheduled by the first DCI is orthogonal to the first-type symbol set” means that all symbols occupied by the channel or signal scheduled by the first DCI are symbols outside the first-type symbol set.

In one embodiment, the feature “the time-domain resource occupied by the channel or the signal scheduled by the first DCI is orthogonal to the first-type symbol set” means that the first-type symbol set does not include any symbol occupied by the channel or signal scheduled by the first DCI.

In one embodiment, the feature “the time-domain resource occupied by the channel or the signal scheduled by the first DCI is orthogonal to the first-type symbol set” means that none of symbols in the first-type symbol set is occupied by the channel or signal scheduled by the first DCI.

### Embodiment 9

Embodiment 9 illustrates a schematic diagram of a relationship between a minimum scheduling offset value set and a time-domain resource occupied by a channel or signal scheduled by a first DCI according to one embodiment of the present application, as shown in FIG. 9. In FIG. 9, Case (a) denotes that the time-domain resource occupied by the channel or the signal scheduled by the first DCI overlaps with a first-type symbol set, and the minimum scheduling offset value set is the first candidate minimum scheduling offset value set; Case (b) denotes that the time-domain resource occupied by the channel or the signal scheduled by the first DCI is orthogonal to the first-type symbol set, and the minimum scheduling offset value set is the second candidate minimum scheduling offset value set.

In Embodiment 9, the multiple candidate minimum scheduling offset value sets are a first candidate minimum scheduling offset value set and a second candidate minimum scheduling offset value set, respectively.

In one embodiment, the multiple candidate minimum scheduling offset value sets are a first candidate minimum scheduling offset value set and a second candidate minimum scheduling offset value set, respectively; the time-domain resource occupied by the channel or the signal scheduled by the first DCI overlaps with a first-type symbol set, and the minimum scheduling offset value set is the first candidate minimum scheduling offset value set; the time-domain resource occupied by the channel or the signal scheduled by the first DCI is orthogonal to the first-type symbol set, and the minimum scheduling offset value set is the second candidate minimum scheduling offset value set.

In one embodiment, the first node of the present application is configured with the first candidate minimum scheduling offset value set and the second candidate minimum scheduling offset value set.

In one embodiment, the first candidate minimum scheduling offset value set and the second candidate minimum scheduling offset value set are both for downlink scheduling.

In one embodiment, the first candidate minimum scheduling offset value set and the second candidate minimum scheduling offset value set are both for uplink scheduling.

In one embodiment, the first node is configured with 2 candidate minimum scheduling offset value sets on an active DL BWP; the 2 candidate minimum scheduling offset value sets being the first candidate minimum scheduling offset value set and the second candidate minimum scheduling offset value set, respectively; the time-domain resource occupied by the channel or the signal scheduled by the first DCI overlaps with a first-type symbol set, and the minimum scheduling offset value set is the first candidate minimum scheduling offset value set; the time-domain resource occupied by the channel or the signal scheduled by the first DCI is orthogonal to the first-type symbol set, and the minimum scheduling offset value set is the second candidate minimum scheduling offset value set.

In one embodiment, the first node is configured with 2 candidate minimum scheduling offset value sets on an active UL BWP; the 2 candidate minimum scheduling offset value sets being the first candidate minimum scheduling offset value set and the second candidate minimum scheduling offset value set, respectively; the time-domain resource occupied by the channel or the signal scheduled by the first DCI overlaps with a first-type symbol set, and the minimum scheduling offset value set is the first candidate minimum scheduling offset value set; the time-domain resource occupied by the channel or the signal scheduled by the first DCI is orthogonal to the first-type symbol set, and the minimum scheduling offset value set is the second candidate minimum scheduling offset value set.

In one embodiment, the first node is configured with 2 candidate minimum scheduling offset value sets on an active DL BWP; the 2 candidate minimum scheduling offset value sets being the first candidate minimum scheduling offset value set and the second candidate minimum scheduling offset value set, respectively; the first node is configured with 2 candidate minimum scheduling offset value sets on an active UL BWP; the 2 candidate minimum scheduling offset value sets being a third candidate minimum scheduling offset value set and a fourth candidate minimum scheduling offset value set, respectively; the time-domain resource occupied by the channel or the signal scheduled by the first DCI overlaps with a first-type symbol set, and the minimum scheduling offset value set on the DL BWP is the first candidate minimum scheduling offset value set and the minimum scheduling offset value set on the UL BWP is the third candidate minimum scheduling offset value set; the time-domain resource occupied by the channel or the signal scheduled by the first DCI is orthogonal to the first-type symbol set, and the minimum scheduling offset value set on the DL BWP is the second candidate minimum scheduling offset value set and the minimum scheduling offset value set on the UL BWP is the fourth candidate minimum scheduling offset value set.

### Embodiment 10

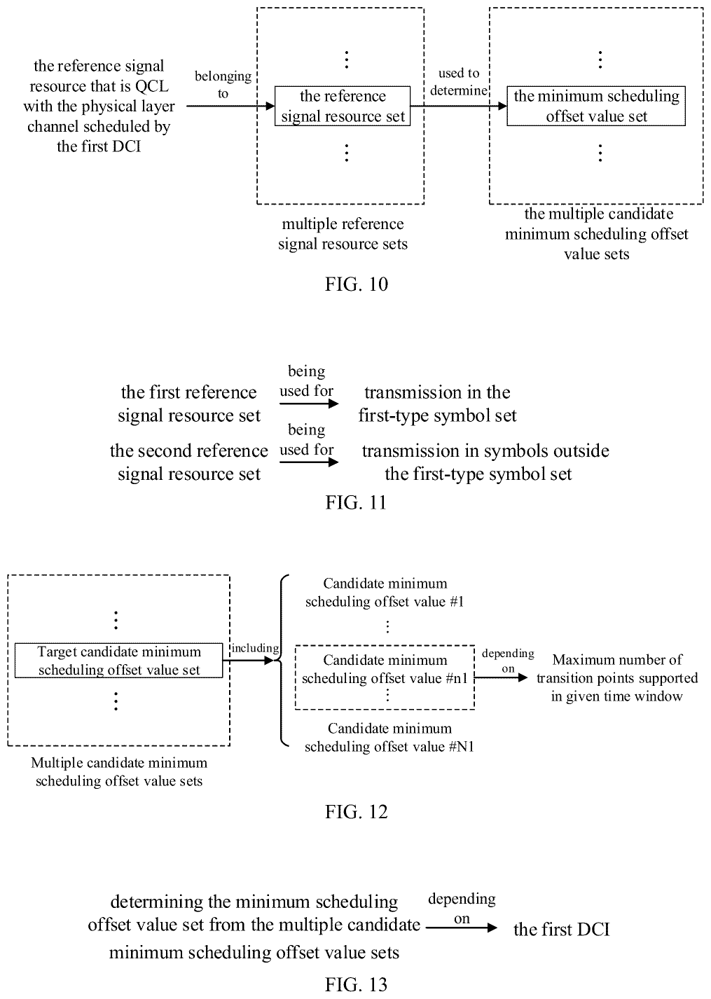

Embodiment 10 illustrates a schematic diagram of a relationship between a minimum scheduling offset value set and a reference signal resource that is QCL with a physical layer channel scheduled by a first DCI according to one embodiment of the present application, as shown in FIG. 10. In FIG. 10, the reference signal resource that is QCL with the physical layer channel scheduled by the first DCI belongs to a reference signal resource set among multiple reference signal resource sets; the reference signal resource set to which the reference signal resource that is QCL with the physical layer channel scheduled by the first DCI belongs is used to determine the minimum scheduling offset value set from the multiple candidate minimum scheduling offset value sets.

In one embodiment, the reference signal resource that is QCL with the physical layer channel scheduled by the first DCI belongs to a reference signal resource set among multiple reference signal resource sets; the reference signal resource set to which the reference signal resource that is QCL with the physical layer channel scheduled by the first DCI belongs is used to determine the minimum scheduling offset value set from the multiple candidate minimum scheduling offset value sets.

In one embodiment, the multiple reference signal resource sets are a first reference signal resource set and a second reference signal resource set, respectively, and the multiple candidate minimum scheduling offset value sets include 2 candidate minimum scheduling offset value sets, the 2 candidate minimum scheduling offset value sets being a first candidate minimum scheduling offset value set and a second candidate minimum scheduling offset value set, respectively; the reference signal resource that is QCL with the physical layer channel scheduled by the first DCI belongs to the first reference signal resource set, and the minimum scheduling offset value set is the first candidate minimum scheduling offset value set; the reference signal resource that is QCL with the physical layer channel scheduled by the first DCI belongs to the second reference signal resource set, and the minimum scheduling offset value set is the second candidate minimum scheduling offset value set.

In one subembodiment, the first node is configured with the 2 candidate minimum scheduling offset value sets respectively on an active UL BWP and an active DL BWP, the 2 candidate minimum scheduling offset value sets on the active UL BWP being different from the 2 candidate minimum scheduling offset value sets on the active DL BWP; the reference signal resource that is QCL with the physical layer channel scheduled by the first DCI belongs to the first reference signal resource set, the minimum scheduling offset value set applied to uplink scheduling is a first candidate minimum scheduling offset value set on the active UL BWP of the first node and the minimum scheduling offset value set applied to downlink scheduling is a first candidate minimum scheduling offset value set on the active DL BWP of the first node; the reference signal resource that is QCL with the physical layer channel scheduled by the first DCI belongs to the second reference signal resource set, the minimum scheduling offset value set applied to uplink scheduling is a second candidate minimum scheduling offset value set on the active UL BWP of the first node and the minimum scheduling offset value set applied to downlink scheduling is a second candidate minimum scheduling offset value set on the active DL BWP of the first node.

In one subsidiary embodiment of the above subembodiment, the minimum scheduling offset value set applied to the uplink scheduling is different from the minimum scheduling offset value set applied to the downlink scheduling.

In one subembodiment, the first reference signal resource set is configured for transmission in the SBFD resources.

In one subembodiment, the second reference signal resource set is configured for transmission in resources other than the SBFD resource.

In one embodiment, the multiple candidate minimum scheduling offset value sets are respectively Q1 candidate minimum scheduling offset value sets, Q1 being a positive integer greater than 2; the Q1 candidate minimum scheduling offset value sets respectively correspond to Q1 reference signal resource sets, and the reference signal resource that is QCL with the physical layer channel scheduled by the first DCI belongs to a given reference signal resource set among the Q1 reference signal resource sets, the given reference signal resource set corresponding to the minimum scheduling offset value set among the Q1 candidate minimum scheduling offset value sets; the given reference signal resource set to which the reference signal resource that is QCL with the physical layer channel scheduled by the first DCI belongs is used to determine the minimum scheduling offset value set out of the Q1 candidate minimum scheduling offset value sets.

In one subembodiment, the first node is configured with Q1 candidate minimum scheduling offset value sets respectively on an active UL BWP and an active DL BWP, the Q1 candidate minimum scheduling offset value sets on the active UL BWP being different from the Q1 candidate minimum scheduling offset value sets on the active DL BWP; the given reference signal resource set to which the reference signal resource that is QCL with the physical layer channel scheduled by the first DCI belongs is used to determine a minimum scheduling offset value set applicable for uplink from the Q1 candidate minimum scheduling offset value sets on the active UL BWP and to determine a minimum scheduling offset value set applicable for downlink from the Q1 candidate minimum scheduling offset value sets on the active DL BWP.

In one subembodiment, there is at least one reference signal resource set among the Q1 reference signal resource sets being configured for transmission in the SBFD resources.

In one embodiment, the reference signal resource set in the present application comprises at least 1 reference signal resource, one of the at least 1 reference signal resource comprising at least one of a CSI-RS resource or an SSB.

In one subembodiment, the reference signal resource set is the first reference signal resource set.

In one subembodiment, the reference signal resource set is the second reference signal resource set.

In one subembodiment, the reference signal resource set is any one of the Q1 reference signal resource sets.

In one subembodiment, the reference signal resource set is one of the Q1 reference signal resource sets.

### Embodiment 11

Embodiment 11 illustrates a schematic diagram of a relationship between multiple reference signal resource sets and a first-type symbol set according to one embodiment of the present application, as shown in FIG. 11. In FIG. 11, a first reference signal resource set is used for transmission in a first-type symbol set; a second reference signal resource set is used for transmission in symbols outside the first-type symbol set.

In Embodiment 11, the multiple reference signal resource sets are the first reference signal resource set and the second reference signal resource set, respectively.

In one embodiment, the multiple reference signal resource sets are a first reference signal resource set and a second reference signal resource set, respectively; the first reference signal resource set being used for transmission in the first-type symbol set and the second reference signal resource set being used for transmission in symbols outside the first-type symbol set; the first-type symbol set includes symbols used for uplink transmission that are indicated as downlink symbols by TDD UL-DL configuration.

In one embodiment, a time-domain resource occupied by a physical layer channel scheduled by the first DCI overlaps with the first-type symbol set, and a reference signal resource that is QCL with the physical layer channel scheduled by the first DCI belongs to the first reference signal resource set; a time-domain resource occupied by the physical layer channel scheduled by the first DCI is orthogonal to the first-type symbol set, and a reference signal resource that is QCL with the physical layer channel scheduled by the first DCI belongs to the second reference signal resource set.

In one embodiment, a symbol occupied by a physical layer channel scheduled by the first DCI belongs to the first-type symbol set, and a reference signal resource that is QCL with the physical layer channel scheduled by the first DCI belongs to the first reference signal resource set; a symbol occupied by the physical layer channel scheduled by the first DCI is a symbol outside the first-type symbol set, and a reference signal resource that is QCL with the physical layer channel scheduled by the first DCI belongs to the second reference signal resource set.

In one embodiment, the first-type symbol set includes the first-type symbols of Embodiment 14 of the present application.

### Embodiment 12

Embodiment 12 illustrates a schematic diagram of a candidate minimum scheduling offset value according to one embodiment of the present application, as shown in FIG. 12. In FIG. 12, multiple candidate minimum scheduling offset value sets include a target candidate minimum scheduling offset value set, and at least one candidate minimum scheduling offset value of multiple candidate minimum scheduling offset values included in the target candidate minimum scheduling offset value set depends on a maximum number of transition points supported in a given time window; the multiple candidate minimum scheduling offset values included in the target candidate minimum scheduling offset value set are denoted as {candidate minimum scheduling offset value #1, . . . , candidate minimum scheduling offset value #n1, . . . , candidate minimum scheduling offset value #N1}, N1 being a positive integer greater than 1.

In one embodiment, the multiple candidate minimum scheduling offset value sets include a target candidate minimum scheduling offset value set, and at least one candidate minimum scheduling offset value of multiple candidate minimum scheduling offset values included in the target candidate minimum scheduling offset value set depends on a maximum number of transition points supported in a given time window.

In one embodiment, the maximum number of transition points supported in the given time window is used to determine at least one candidate minimum scheduling offset value among multiple candidate minimum scheduling offset values included in the target candidate minimum scheduling offset value set.

In one embodiment, the given candidate minimum scheduling offset value is the at least one candidate minimum offset value that exists, the given candidate minimum scheduling offset value being linearly correlated with a maximum number of transition points supported in the given time window.

In one embodiment, the given candidate minimum scheduling offset value is the at least one candidate minimum offset value that exists, the given candidate minimum scheduling offset value being dependent on a product of a first value and a maximum number of transition points supported in the given time window.

In one subembodiment, the first value is measured in milliseconds.

In one subembodiment, the first value is measured in slots.

In one subembodiment, the first value is measured in symbols.

In one embodiment, the given time window is a duration of a slot.

In one embodiment, the given time window is a duration of a subframe.

In one embodiment, the given time window is a TDD UL/DL pattern period.

In one embodiment, the given time window is a duration of W1 consecutive slots, W1 being a positive integer greater than 1.

In one subembodiment, W1 is equal to 10.

In one subembodiment, W1 is equal to 20.

In one subembodiment, W1 is equal to 40.

In one embodiment, the given time window is a positive integer number of millisecond(s).

In one embodiment, the transition points refer to transition points between SBFD symbols and non-SBFD symbols.

In one embodiment, the transition points refer to transition points between full-duplex symbols and non-full-duplex symbols.

In one embodiment, the transition points refer to transition points between non-SBFD symbols and SBFD symbols.

In one embodiment, the transition points refer to transition points between non-full-duplex symbols and full-duplex symbols.

In one embodiment, the transition points refer to transition points between SBFD symbols and non-SBFD symbols as well as transition points between non-SBFD symbols and SBFD symbols.

In one embodiment, the transition points refer to transition points between full-duplex symbols and non-full-duplex symbols as well as transition points between non-full-duplex symbols and full-duplex symbols.

In one embodiment, the transition points refer to transition points between symbols in the first-type symbol set and symbols outside the first-type symbol set.

In one embodiment, the transition points refer to transition points between symbols outside the first-type symbol set and symbols in the first-type symbol set.

In one embodiment, the transition points refer to transition points between symbols in the first-type symbol set and symbols outside the first-type symbol set as well as transition points between symbols outside the first-type symbol set and symbols in the first-type symbol set.

### Embodiment 13

Embodiment 13 illustrates a schematic diagram of a relationship between a first DCI and a minimum scheduling offset value set according to one embodiment of the present application, as shown in FIG. 13. In FIG. 13, determining the minimum scheduling offset value set from the multiple candidate minimum scheduling offset value sets depends on the first DCI.

In Embodiment 13, the first DCI does not include a carrier indicator field, or a value of the carrier indicator field included in the first DCI is fixed.

In one embodiment, determining the minimum scheduling offset value set from the multiple candidate minimum scheduling offset value sets depends on the resource occupied by the first DCI, the first DCI does not include a carrier indicator field, or a value of the carrier indicator field included in the first DCI is fixed.

In one embodiment, determining the minimum scheduling offset value set from the multiple candidate minimum scheduling offset value sets depends on a spatial-domain resource associated with the first DCI, the first DCI does not include a carrier indicator field, or a value of the carrier indicator field included in the first DCI is fixed; the spatial-domain resource associated with the first DCI comprises the reference signal resource that is QCL with the physical layer channel scheduled by the first DCI.

In one embodiment, that the first DCI does not include a carrier indicator field means that the first DCI includes no Carrier Indicator Field (CIF).

In one embodiment, the statement that a value of the carrier indicator field included in the first DCI is fixed means that the value indicated by the carrier indicator field included in the first DCI is all-zeros.

In one embodiment, the statement that a value of the carrier indicator field included in the first DCI is fixed means that the value indicated by the carrier indicator field included in the first DCI is all-ones.

In one embodiment, the statement that a value of the carrier indicator field included in the first DCI is fixed means that the value indicated by the carrier indicator field included in the first DCI is pre-defined.

In one embodiment, the statement that a value of the carrier indicator field included in the first DCI is fixed means that the value indicated by the carrier indicator field included in the first DCI is not used for cross-carrier scheduling.

### Embodiment 14

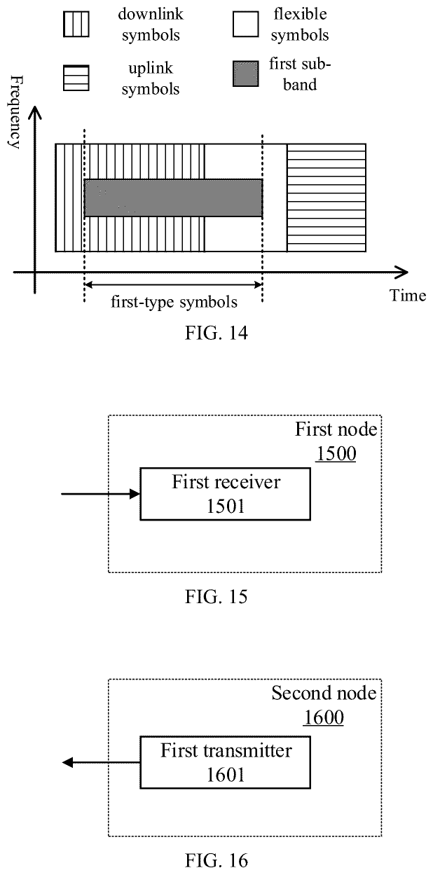

Embodiment 14 illustrates a schematic diagram of a first-type symbol set according to one embodiment of the present application, as shown in FIG. 14. In FIG. 14, the horizontal axis denotes time and the vertical axis denotes frequency; the zone filled with vertical lines denotes in time the time-domain resources occupied by downlink symbols, the zone filled with horizontal lines denotes in time the time-domain resources occupied by uplink symbols, the zone without filling denotes in time the time-domain resources occupied by flexible symbols, the zone filled with solid gray color denotes a first sub-band, and the first sub-band occupies a zone that denotes in frequency the frequency-domain resources in the downlink and flexible symbols that can be used for uplink transmission.

In Embodiment 14, first-type symbols include downlink symbols and flexible symbols used for uplink transmission in the first sub-band that are indicated by TDD UL-DL configuration, the first-type symbol set including the first-type symbols.

In one embodiment, the TDD refers to: Time Division Duplexing.

In one embodiment, the TDD refers to: Time Division Duplex.

In one embodiment, the TDD uplink-downlink configuration is indicated via a Radio Resource Control (RRC) signaling.

In one embodiment, the TDD uplink-downlink configuration is indicated via a TDD-UL-DL-ConfigCommon Information Element (IE).

In one embodiment, the TDD uplink-downlink configuration is indicated via a TDD-UL-DL-ConfigDedicated IE.

In one embodiment, the TDD uplink-downlink configuration is indicated via at least the former of a TDD-UL-DL-ConfigCommon IE and a TDD-UL-DL-ConfigDedicated IE.

In one embodiment, the TDD uplink-downlink configuration is indicated via a TDD-UL-DL-Pattern field.

In one embodiment, a name of an RRC signaling carrying the TDD uplink-downlink configuration includes “TDD”.

In one embodiment, a name of an RRC signaling carrying the TDD uplink-downlink configuration includes “DL”.

In one embodiment, a name of an RRC signaling carrying the TDD uplink-downlink configuration includes “UL”.

In one embodiment, a name of an RRC signaling carrying the TDD uplink-downlink configuration includes “Config”.

In one embodiment, a name of an RRC signaling carrying the TDD uplink-downlink configuration includes “Common”.

In one embodiment, a name of an RRC signaling carrying the TDD uplink-downlink configuration includes “SBFD”.

In one embodiment, a name of an RRC signaling carrying the TDD uplink-downlink configuration includes “subband”.

In one embodiment, a name of an RRC signaling carrying the TDD uplink-downlink configuration includes “duplex”.

In one embodiment, the TDD uplink-downlink configuration is indicated via a Medium Access Control (MAC) Control Element (CE).

In one embodiment, the TDD uplink-downlink configuration is indicated via a DCI.

In one embodiment, the TDD uplink-downlink configuration is indicated via RRC layer signaling and physical layer signaling together.

In one embodiment, the TDD uplink-downlink configuration is carried by RRC layer signaling and physical layer signaling together.

In one subembodiment, the RRC signaling comprises at least a former of a TDD-UL-DL-ConfigCommon IE and a TDD-UL-DL-ConfigDedicated IE.

In one subembodiment, the physical layer signaling comprises part of or all fields of a DCI.

In one subembodiment, the physical layer signaling is a Slot Format Indicator (SFI).

In one embodiment, the TDD uplink-downlink configuration indicates downlink slots and downlink symbols during a period.

In one embodiment, the TDD uplink-downlink configuration indicates that during a period at least 1 slot is a downlink slot and/or that at least one symbol is a downlink symbol.

In one embodiment, the first sub-band occupies at least one Resource Block (RB) set in frequency domain.

In one subembodiment, the one RB set is a set of contiguous RBs.

In one subembodiment, the RB set is configured by a higher layer parameter “IntraCellGuardBandsPerSCS”.

In one subembodiment, the RB set is configured by a higher layer parameter “intraCellGuardBandsUL-List”.

In one subembodiment, a guard band exists between two neighboring RB sets.

In one embodiment, there exist guard bands at both ends of the first sub-band in frequency domain.

In one embodiment, there exists a guard band at one end of the first sub-band in frequency domain.

In one embodiment, there exist no guard bands at both ends of the first sub-band in frequency domain.

In one subembodiment of the above three embodiments, the guard band is not used for uplink transmission or downlink transmission.

In one embodiment, the first sub-band occupies at least one RB in frequency domain.

In one subembodiment, the at least one RB includes one RB.

In one subembodiment, the at least one RB includes a plurality of consecutive RBs.

In one embodiment, the RB in the present application includes Physical Resource Block (PRB).

In one embodiment, the RB in the present application refers to PRB.

Typically, an RB occupies 12 consecutive subcarriers in frequency domain.

In one embodiment, the first sub-band occupies a plurality of subcarriers in frequency domain.

In one embodiment, the first sub-band belongs to a UL carrier.

In one embodiment, frequency-domain resources occupied by the first sub-band belong to one UL carrier.

In one embodiment, the UL carrier in this application comprises a Normal Uplink (NUL) carrier.

In one embodiment, the UL carrier in the present application comprises a Supplementary UL (SUL) carrier.

In one embodiment, the first sub-band belongs to a DL carrier.

In one embodiment, frequency-domain resources occupied by the first sub-band belong to one DL carrier.

In one embodiment, the first sub-band belongs to a BWP.

In one embodiment, the first sub-band belongs to a UL BWP.

In one embodiment, frequency-domain resources occupied by the first sub-band belong to a UL BWP.

In one embodiment, the first sub-band belongs to a DL BWP.

In one embodiment, frequency-domain resources occupied by the first sub-band belong to a DL BWP.

In one embodiment, there is overlapping frequency-domain resource between the first sub-band and a UL BWP.

In one embodiment, there is no overlapping frequency-domain resource between the first sub-band and a UL BWP.

In one embodiment, the first sub-band comprises a SubBand non-overlapping Full Duplex (SBFD) subband.

In one embodiment, the first sub-band is an SBFD subband.

In one embodiment, the one SBFD subband in this application is used for uplink transmission.

In one embodiment, the one SBFD subband in this application is capable of being (or can or is allowed to be) used for uplink transmission.

In one embodiment, the one SBFD subband in this application is a UL subband.

In one embodiment, the first-type symbol set comprises a positive integer number of symbols.

In one embodiment, the first-type symbol set comprises the first-type symbols.

In one embodiment, the first-type symbol set comprises only the first-type symbols.

In one embodiment, the first-type symbol set comprises full duplex symbols.

In one embodiment, the first-type symbol set comprises SBFD symbols.

In one embodiment, symbols in the first-type symbol set are configured for SBFD.

In one embodiment, the first-type symbol set comprises a downlink symbol for uplink transmission that is indicated by TDD uplink-downlink (UL-DL) configuration.

In one embodiment, the first-type symbol set comprises a flexible symbol for uplink transmission that is indicated by TDD uplink-downlink (UL-DL) configuration.

In one embodiment, the symbols in the first-type symbol set are downlink symbols for uplink transmission that are indicated by TDD uplink-downlink (UL-DL) configuration.

In one embodiment, any symbol in the first-type symbol set is a downlink symbol for uplink transmission that is indicated by TDD uplink-downlink (UL-DL) configuration or a flexible symbol for uplink transmission that is indicated by TDD UL-DL configuration.

In one embodiment, symbols in the first-type symbol set are configured to be capable of (or can or be allowed to be) performing uplink transmission in the first sub-band.

In one embodiment, symbols in the first-type symbol set are indicated to be capable of (or can or be allowed to be) performing uplink transmission in the first sub-band.

In one embodiment, symbols in the first-type symbol set are configured to be actually performing uplink transmission in the first sub-band.

In one embodiment, symbols in the first-type symbol set are indicated to be actually performing uplink transmission in the first sub-band.

In one embodiment, the first sub-band is indicated to enable on symbols in the first-type symbol set.

In one embodiment, symbols in the first-type symbol set are used for both transmission and reception.

In one embodiment, symbols in the first-type symbol set support simultaneous uplink transmission and downlink transmission.

In one embodiment, a transmitter of the first DCI receives and transmits radio signals simultaneously on symbols in the first-type symbol set.

In one embodiment, a transmitter of the first DCI performs uplink and downlink transmissions simultaneously on symbols in the first-type symbol set.

In one embodiment, a transmitter of the first DCI receives radio signals on frequency-domain resources included in the first sub-band of the symbols in the first-type symbol set and transmits radio signals on frequency-domain resources other than those included in the first sub-band.

In one embodiment, a transmitter of the first DCI performs uplink transmission on frequency-domain resources included in the first sub-band of the symbols in the first-type symbol set and performs downlink transmission on frequency-domain resources other than those included in the first sub-band.

### Embodiment 15

Embodiment 15 illustrates a structure block diagram of a processing device used in a first node according to one embodiment of the present application, as shown in FIG. 15. In FIG. 15, a processing device 1500 in a first node comprises a first receiver 1501.

In Embodiment 15, the first receiver 1501 receives a first DCI, the first DCI comprising a first field, the first field in the first DCI being used to indicate a minimum applicable scheduling offset.

In Embodiment 15, the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
a resource occupied by the first DCI; or
a time-domain resource occupied by a channel or signal scheduled by the first DCI; or
a reference signal resource that is QCL with a physical layer channel scheduled by the first DCI.

In one embodiment, the resource occupied by the first DCI includes a CORESET pool; the CORESET pool occupied by the first DCI is used to determine the minimum scheduling offset value set from the multiple candidate minimum scheduling offset value sets.

In one embodiment, the multiple candidate minimum scheduling offset value sets are a first candidate minimum scheduling offset value set and a second candidate minimum scheduling offset value set, respectively; the time-domain resource occupied by the channel or the signal scheduled by the first DCI overlaps with a first-type symbol set, and the minimum scheduling offset value set is the first candidate minimum scheduling offset value set; the time-domain resource occupied by the channel or the signal scheduled by the first DCI is orthogonal to the first-type symbol set, and the minimum scheduling offset value set is the second candidate minimum scheduling offset value set.

In one embodiment, the reference signal resource that is QCL with the physical layer channel scheduled by the first DCI belongs to a reference signal resource set among multiple reference signal resource sets; the reference signal resource set to which the reference signal resource that is QCL with the physical layer channel scheduled by the first DCI belongs is used to determine the minimum scheduling offset value set from the multiple candidate minimum scheduling offset value sets.

In one embodiment, the multiple candidate minimum scheduling offset value sets include a target candidate minimum scheduling offset value set, and at least one candidate minimum scheduling offset value of multiple candidate minimum scheduling offset values included in the target candidate minimum scheduling offset value set depends on a maximum number of transition points supported in a given time window.

In one embodiment, determining the minimum scheduling offset value set from the multiple candidate minimum scheduling offset value sets depends on the first DCI, the first DCI does not include a carrier indicator field, or a value of the carrier indicator field included in the first DCI is fixed.

In one embodiment, the CORESET pool occupied by the first DCI is a first CORESET pool or a second CORESET pool, the first CORESET pool being used for scheduling in the first-type symbol set and the second CORESET pool being used for scheduling in symbols outside the first-type symbol set; or, the multiple reference signal resource sets are a first reference signal resource set and a second reference signal resource set, respectively, the first reference signal resource set being used for transmission in the first-type symbol set and the second reference signal resource set being used for transmission in symbols outside the first-type symbol set; the first-type symbol set includes symbols used for uplink transmission that are indicated as downlink symbols by TDD Uplink-Downlink (UL-DL) configuration.

In one embodiment, the minimum applicable scheduling offset is applied to an active BWP, the first node assumes that any scheduling delay from a channel or signal scheduled by a DCI on the active BWP to the DCI is no smaller than the minimum applicable scheduling offset before a new minimum applicable scheduling offset for the active BWP takes effect.

In one embodiment, the minimum applicable scheduling offset is applied to an active BWP, the first node assumes that any scheduling delay from a channel or signal scheduled by a DCI on the active BWP to the DCI is no smaller than the minimum applicable scheduling offset after the minimum applicable scheduling offset takes effect.

In one embodiment, the first node 1500 is configured with the minimum scheduling offset value set respectively on an active UL BWP and an active DL BWP, and the first field of the first node indicates a minimum applicable scheduling offset from the minimum scheduling offset value set on the active UL BWP, the minimum applicable scheduling offset being applied to uplink scheduling; and, the first field of the first node indicates a minimum applicable scheduling offset from the minimum scheduling offset value set on the active DL BWP, the minimum applicable scheduling offset being applied to downlink scheduling.

In one embodiment, symbols in the first-type symbol set are used for both transmission and reception.

In one embodiment, symbols in the first-type symbol set support simultaneous uplink transmission and downlink transmission.

In one embodiment, a transmitter of the first DCI receives and transmits radio signals simultaneously on symbols in the first-type symbol set.

In one embodiment, a transmitter of the first DCI performs uplink and downlink transmissions simultaneously on symbols in the first-type symbol set.

In one embodiment, the first node is a UE.

In one embodiment, the first node is a relay node.

In one embodiment, the first receiver 1501 comprises at least one of the antenna 452, the receiver 454, the receiving processor 456, the multi-antenna receiving processor 458, the controller/processor 459, the memory 460 or the data source 467 in Embodiment 4.

### Embodiment 16

Embodiment 16 illustrates a structure block diagram of a processing device used in a second node according to one embodiment of the present application, as shown in FIG. 16. In FIG. 16, a processing device 1600 in a second node comprises a first transmitter 1601.

In Embodiment 16, the first transmitter 1601 transmits a first DCI, the first DCI comprising a first field, the first field in the first DCI being used to indicate a minimum applicable scheduling offset.

In Embodiment 16, the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
a resource occupied by the first DCI; or
a time-domain resource occupied by a channel or signal scheduled by the first DCI; or
a reference signal resource that is QCL with a physical layer channel scheduled by the first DCI.

In one embodiment, the resource occupied by the first DCI includes a CORESET pool; the CORESET pool occupied by the first DCI is used to determine the minimum scheduling offset value set from the multiple candidate minimum scheduling offset value sets.

In one embodiment, the multiple candidate minimum scheduling offset value sets are a first candidate minimum scheduling offset value set and a second candidate minimum scheduling offset value set, respectively; the time-domain resource occupied by the channel or the signal scheduled by the first DCI overlaps with a first-type symbol set, and the minimum scheduling offset value set is the first candidate minimum scheduling offset value set; the time-domain resource occupied by the channel or the signal scheduled by the first DCI is orthogonal to the first-type symbol set, and the minimum scheduling offset value set is the second candidate minimum scheduling offset value set.

In one embodiment, the reference signal resource that is QCL with the physical layer channel scheduled by the first DCI belongs to a reference signal resource set among multiple reference signal resource sets; the reference signal resource set to which the reference signal resource that is QCL with the physical layer channel scheduled by the first DCI belongs is used to determine the minimum scheduling offset value set from the multiple candidate minimum scheduling offset value sets.

In one embodiment, the multiple candidate minimum scheduling offset value sets include a target candidate minimum scheduling offset value set, and at least one candidate minimum scheduling offset value of multiple candidate minimum scheduling offset values included in the target candidate minimum scheduling offset value set depends on a maximum number of transition points supported in a given time window.

In one embodiment, determining the minimum scheduling offset value set from the multiple candidate minimum scheduling offset value sets depends on the first DCI, the first DCI does not include a carrier indicator field, or a value of the carrier indicator field included in the first DCI is fixed.

In one embodiment, the CORESET pool occupied by the first DCI is a first CORESET pool or a second CORESET pool, the first CORESET pool being used for scheduling in the first-type symbol set and the second CORESET pool being used for scheduling in symbols outside the first-type symbol set; or, the multiple reference signal resource sets are a first reference signal resource set and a second reference signal resource set, respectively, the first reference signal resource set being used for transmission in the first-type symbol set and the second reference signal resource set being used for transmission in symbols outside the first-type symbol set; the first-type symbol set includes symbols used for uplink transmission that are indicated as downlink symbols by TDD Uplink-Downlink (UL-DL) configuration.

In one embodiment, the minimum applicable scheduling offset is applied to an active BWP, the first node assumes that any scheduling delay from a channel or signal scheduled by a DCI on the active BWP to the DCI is no smaller than the minimum applicable scheduling offset before a new minimum applicable scheduling offset for the active BWP takes effect.

In one embodiment, the minimum applicable scheduling offset is applied to an active BWP, the first node assumes that any scheduling delay from a channel or signal scheduled by a DCI on the active BWP to the DCI is no smaller than the minimum applicable scheduling offset after the minimum applicable scheduling offset takes effect.

In one embodiment, the receiver of the first DCI is configured with the minimum scheduling offset value set respectively on an active UL BWP and an active DL BWP, and the first field of the first node indicates a minimum applicable scheduling offset from the minimum scheduling offset value set on the active UL BWP, the minimum applicable scheduling offset being applied to uplink scheduling; and, the first field of the first node indicates a minimum applicable scheduling offset from the minimum scheduling offset value set on the active DL BWP, the minimum applicable scheduling offset being applied to downlink scheduling.

In one embodiment, symbols in the first-type symbol set are used for both transmission and reception.

In one embodiment, symbols in the first-type symbol set support simultaneous uplink transmission and downlink transmission.

In one embodiment, the second node 1600 receives and transmits radio signals simultaneously on symbols in the first-type symbol set.

In one embodiment, the second node 1600 performs uplink and downlink transmissions simultaneously on symbols in the first-type symbol set.

In one embodiment, the second node is a base station.

In one embodiment, the second node is a UE.

In one embodiment, the second node is a relay node.

In one embodiment, the first transmitter 1601 comprises at least one of the antenna 420, the transmitter 418, the transmitting processor 416, the multi-antenna transmitting processor 471, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, vehicles, automobiles, RSU, wireless sensor, network cards, terminals for Internet of Things (IoT), Radio Frequency Identification (RFID) terminals, Narrow Band Internet of Things (NB-IoT) terminals, Machine Type Communication (MTC) terminals, enhanced MTC (eMTC) terminals, data cards, low-cost mobile phones, low-cost tablet computers, etc. The base station or system device in the present application includes but is not limited to macro-cellular base stations, micro-cellular base stations, home base stations, relay base station, evolved Node B/eNB, gNB, Transmitter Receiver Point (TRP), Global Navigation Satellite System (GNSS), relay satellite, satellite base station, airborne base station, Road Side Unit (RSU), drones, test equipment like transceiving device simulating partial functions of base station or signaling tester.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, comprising:
a first receiver, receiving a first DCI, the first DCI comprising a first field, the first field in the first DCI being used to indicate a minimum applicable scheduling offset;
wherein the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
a resource occupied by the first DCI; or
a time-domain resource occupied by a channel or signal scheduled by the first DCI; or
a reference signal resource that is QCL with a physical layer channel scheduled by the first DCI.

2. The first node according to claim 1, characterized in that the resource occupied by the first DCI includes a CORESET pool; the CORESET pool occupied by the first DCI is used to determine the minimum scheduling offset value set from the multiple candidate minimum scheduling offset value sets.

3. The first node according to claim 1, characterized in that the multiple candidate minimum scheduling offset value sets are a first candidate minimum scheduling offset value set and a second candidate minimum scheduling offset value set, respectively; the time-domain resource occupied by the channel or the signal scheduled by the first DCI overlaps with a first-type symbol set, and the minimum scheduling offset value set is the first candidate minimum scheduling offset value set; the time-domain resource occupied by the channel or the signal scheduled by the first DCI is orthogonal to the first-type symbol set, and the minimum scheduling offset value set is the second candidate minimum scheduling offset value set.

4. The first node according to claim 1, characterized in that the reference signal resource that is QCL with the physical layer channel scheduled by the first DCI belongs to a reference signal resource set among multiple reference signal resource sets; the reference signal resource set to which the reference signal resource that is QCL with the physical layer channel scheduled by the first DCI belongs is used to determine the minimum scheduling offset value set from the multiple candidate minimum scheduling offset value sets.

5. The first node according to claim 1, characterized in that the multiple candidate minimum scheduling offset value sets include a target candidate minimum scheduling offset value set, and at least one candidate minimum scheduling offset value of multiple candidate minimum scheduling offset values included in the target candidate minimum scheduling offset value set depends on a maximum number of transition points supported in a given time window.

6. The first node according to claim 1, characterized in that determining the minimum scheduling offset value set from the multiple candidate minimum scheduling offset value sets depends on the first DCI, the first DCI does not include a carrier indicator field, or a value of the carrier indicator field included in the first DCI is fixed.

7. The first node according to claim 2, characterized in that the CORESET pool occupied by the first DCI is a first CORESET pool or a second CORESET pool, the first CORESET pool being used for scheduling in the first-type symbol set and the second CORESET pool being used for scheduling in symbols outside the first-type symbol set; or, the multiple reference signal resource sets are a first reference signal resource set and a second reference signal resource set, respectively, the first reference signal resource set being used for transmission in the first-type symbol set and the second reference signal resource set being used for transmission in symbols outside the first-type symbol set; the first-type symbol set includes symbols used for uplink transmission that are indicated as downlink symbols by TDD Uplink-Downlink (UL-DL) configuration.

8. The first node according to claim 2, characterized in that the multiple candidate minimum scheduling offset value sets are a first candidate minimum scheduling offset value set and a second candidate minimum scheduling offset value set, Q1 being equal to 2; the first DCI occupies a first CORESET pool, and the minimum scheduling offset value set is the first candidate minimum scheduling offset value set; the first DCI occupies a second CORESET pool, and the minimum scheduling offset value set is the second candidate minimum scheduling offset value set; the first CORESET pool is different from the second CORESET pool.

9. The first node according to claim 8, characterized in that the first CORESET pool and the second CORESET pool correspond to a PCI and an AdditionalPCI, respectively.

10. The first node according to claim 3, characterized in that first-type symbols include downlink symbols and flexible symbols used for uplink transmission in the first subband that are indicated by TDD UL-DL configuration, the first-type symbol set including the first-type symbols.

11. The first node according to claim 3, characterized in that the first-type symbol set includes SBFD symbols.

12. The first node according to claim 4, characterized in that the multiple reference signal resource sets are a first reference signal resource set and a second reference signal resource set, respectively, and the multiple candidate minimum scheduling offset value sets include 2 candidate minimum scheduling offset value sets, the 2 candidate minimum scheduling offset value sets being a first candidate minimum scheduling offset value set and a second candidate minimum scheduling offset value set, respectively; the reference signal resource that is QCL with the physical layer channel scheduled by the first DCI belongs to the first reference signal resource set, and the minimum scheduling offset value set is the first candidate minimum scheduling offset value set; the reference signal resource that is QCL with the physical layer channel scheduled by the first DCI belongs to the second reference signal resource set, and the minimum scheduling offset value set is the second candidate minimum scheduling offset value set.

13. The first node according to claim 5, characterized in that the transition points refer to transition points between SBFD symbols and non-SBFD symbols.

14. A second node for wireless communications, comprising:
a first transmitter, transmitting a first DCI, the first DCI comprising a first field, the first field in the first DCI being used to indicate a minimum applicable scheduling offset;
wherein the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
a resource occupied by the first DCI; or
a time-domain resource occupied by a channel or signal scheduled by the first DCI; or
a reference signal resource that is QCL with a physical layer channel scheduled by the first DCI.

15. The second node according to claim 14, characterized in that the resource occupied by the first DCI includes a CORESET pool; the CORESET pool occupied by the first DCI is used to determine the minimum scheduling offset value set from the multiple candidate minimum scheduling offset value sets.

16. The second node according to claim 14, characterized in that the multiple candidate minimum scheduling offset value sets are a first candidate minimum scheduling offset value set and a second candidate minimum scheduling offset value set, respectively; the time-domain resource occupied by the channel or the signal scheduled by the first DCI overlaps with a first-type symbol set, and the minimum scheduling offset value set is the first candidate minimum scheduling offset value set; the time-domain resource occupied by the channel or the signal scheduled by the first DCI is orthogonal to the first-type symbol set, and the minimum scheduling offset value set is the second candidate minimum scheduling offset value set.

17. The second node according to claim 14, characterized in that the reference signal resource that is QCL with the physical layer channel scheduled by the first DCI belongs to a reference signal resource set among multiple reference signal resource sets; the reference signal resource set to which the reference signal resource that is QCL with the physical layer channel scheduled by the first DCI belongs is used to determine the minimum scheduling offset value set from the multiple candidate minimum scheduling offset value sets.

18. The second node according to claim 14, characterized in that the multiple candidate minimum scheduling offset value sets include a target candidate minimum scheduling offset value set, and at least one candidate minimum scheduling offset value of multiple candidate minimum scheduling offset values included in the target candidate minimum scheduling offset value set depends on a maximum number of transition points supported in a given time window.

19. The second node according to claim 14, characterized in that determining the minimum scheduling offset value set from the multiple candidate minimum scheduling offset value sets depends on the first DCI, the first DCI does not include a carrier indicator field, or a value of the carrier indicator field included in the first DCI is fixed.

20. A method in a first node for wireless communications, comprising:
receiving a first DCI, the first DCI comprising a first field, the first field in the first DCI being used to indicate a minimum applicable scheduling offset;
wherein the first field in the first DCI indicates the minimum applicable scheduling offset in a minimum scheduling offset value set, the minimum scheduling offset value set including K1 candidate minimum scheduling offset values, the minimum applicable scheduling offset being one of the K1 candidate minimum scheduling offset values; the minimum scheduling offset value set is one of multiple candidate minimum scheduling offset value sets, K1 being a positive integer greater than 1; determining the minimum scheduling offset value set from the multiple candidate minimum scheduling offset value sets depends on one of:
a resource occupied by the first DCI; or
a time-domain resource occupied by a channel or signal scheduled by the first DCI; or
a reference signal resource that is QCL with a physical layer channel scheduled by the first DCI.
